(19) United States
(12) Patent Application Publication
(10) Pub. No.: US 2025/0393073 A1
(43) Pub. Date: Dec. 25, 2025

(54) DYNAMIC UNAVAILABILITY OPERATION FOR WIRELESS NETWORK

(71) Applicant: Samsung Electronics Co., Ltd., Suwon-si (KR)

(72) Inventors: Peshal Nayak, Plano, TX (US); Rubayet Shafin, Allen, TX (US); Bilal Sadiq, Plano, TX (US); Vishnu Vardhan Ratnam, Frisco, TX (US); Yue Qi, Plano, TX (US); Boon Loong Ng, Plano, TX (US)

(21) Appl. No.: 19/239,814

(22) Filed: Jun. 16, 2025

Related U.S. Application Data
(60) Provisional application No. 63/663,523, filed on Jun. 24, 2024.
(60) Provisional application No. 63/672,531, filed on Jul. 17, 2024.
(60) Provisional application No. 63/718,282, filed on Nov. 8, 2024.
(60) Provisional application No. 63/761,718, filed on Feb. 21, 2025.
(60) Provisional application No. 63/802,237, filed on May 8, 2025.

(51) Int. Cl. H04W 74/0816; H04L 5/00; H04W 74/00

(52) U.S. Cl. CPC H04W 74/0816; H04L 5/0053; H04W 74/002

(57) ABSTRACT

A station (STA) in a wireless network includes a memory and a processor coupled to the memory, the processor is to cause transmitting, to an AP, a first request frame to enable a mode of operation for the STA, wherein the mode of operation is a DUO mode associated with a duration during which the STA is unavailable. The processor is further to cause receiving, from the AP, a first response frame indicating that the AP is ready to serve the STA in the DUO mode, receiving, from the AP, an initial control frame (ICF) that solicits unavailability information from the STA and transmitting, to the AP, an initial control response (ICR) frame in response to the ICF, the ICR indicating unavailability information.

### CROSS-REFERENCE TO RELATED APPLICATION(S)

This application claims the benefit of priority from U.S. Provisional Application No. 63/663,523, entitled “BEACON MANAGEMENT UNDER COEXISTENCE CONSTRAINT FOR NEXT GENERATION WLAN,” filed Jun. 24, 2024; U.S. Provisional Application No. 63/672,531, entitled “SESSION BASED CO-EX OPERATION FOR NEXT GENERATION WLANS,” filed Jul. 17, 2024; U.S. Provisional Application No. 63/718,282, entitled “SESSION BASED CO-EX OPERATION FOR NEXT GENERATION WLANS,” filed Nov. 8, 2024; U.S. Provisional Application No. 63/761,718, entitled “SESSION BASED CO-EX OPERATION FOR NEXT GENERATION WLANS,” filed Feb. 21, 2025; and U.S. Provisional Application No. 63/802,237, entitled “SESSION BASED CO-EX OPERATION FOR NEXT GENERATION WLANS,” filed May 8, 2025, all which are incorporated herein by reference in their entirety.

### TECHNICAL FIELD

This disclosure relates generally to a wireless communication system, and more particularly to, for example, but not limited to, dynamic unavailability operation (DUO) in wireless networks.

### BACKGROUND

Wireless local area network (WLAN) technology has evolved toward increasing data rates and continues its growth in various markets such as home, enterprise and hotspots over the years since the late 1990s. WLAN allows devices to access the internet in the 2.4 GHZ, 5 GHZ, 6 GHz or 60 GHz frequency bands. WLANs are based on the Institute of Electrical and Electronic Engineers (IEEE) 802.11 standards. IEEE 802.11 family of standards aims to increase speed and reliability and to extend the operating range of wireless networks.

WLAN devices are increasingly required to support a variety of delay-sensitive applications or real-time applications such as augmented reality (AR), robotics, artificial intelligence (AI), cloud computing, and unmanned vehicles. To implement extremely low latency and extremely high throughput required by such applications, multi-link operation (MLO) has been suggested for the WLAN. The WLAN is formed within a limited area such as a home, school, apartment, or office building by WLAN devices. Each WLAN device may have one or more stations (STAs) such as the access point (AP) STA and the non-access point (non-AP) STA.

The MLO may enable a non-AP multi-link device (MLD) to set up multiple links with an AP MLD. Each of multiple links may enable channel access and frame exchanges between the non-AP MLD and the AP MLD independently, which may reduce latency and increase throughput.

While WLAN has been evolving, other technologies have also emerged and continued to grow in various markets such as home and enterprise. Some examples include short range personal area network (PAN) or wireless personal area network (WPAN). For example, Bluetooth is a short-range wireless technology used to connect devices enabling data to be exchanged. In other examples, the WPAN could be an example of a Zigbee network or technology. In at least one example, Zigbee refers to a standards-based wireless mesh network—e.g., used to create personal area networks with small low-powered digital radios. Additionally, ultra-wideband (UWB) is emerging as a radio technology that can use a lower energy level for high-bandwidth communications. Some examples of UWB applications include data collection, precise locating, and tracking. These and other technologies can operate on protocols different than the WLAN networks—e.g., operate with protocols not compliant with WLAN. However, some of the technologies share similar channel usage, a same frequency band, and/or interfere with the WLAN network. In other examples, some devices can include multiple radio technologies and each one may use a same antenna in the device—e.g., a device can use a same antenna for Wi-Fi and Bluetooth. As these technologies grow, their potential interference problem with subsequent Wi-Fi generations worsens. Accordingly a mechanism to reduce interference is needed.

The description set forth in the background section should not be assumed to be prior art merely because it is set forth in the background section. The background section may describe aspects or embodiments of the present disclosure.

### SUMMARY

An aspect of the present disclosure provides for a station (STA) in a wireless network, comprising: a memory; and a processor coupled to the memory, the processor configured to cause: transmitting, to an access point (AP) associated with the STA, a first request frame to enable a mode of operation for the STA, wherein the mode of operation requested is a dynamic unavailability operation (DUO) mode associated with a duration during which the STA is unavailable; receiving, from the AP, a first response frame indicating that the AP is ready to serve the STA in the DUO mode; receiving, from the AP, an initial control frame (ICF) that solicits unavailability information from the STA; and transmitting, to the AP, an initial control response (ICR) frame, the ICR frame indicating unavailability information.

In an embodiment, the processor is further configured to cause transmitting, to the AP, a second request frame to disable the mode of operation, wherein the second request frame includes a field value set to a first value to indicate the request to disable the DUO mode and receiving, from the AP, a second response frame indicating the AP is no longer serving the STA in the DUO mode in response to the second request frame.

In an embodiment, the second request frame includes at least one of an indication that the second request frame is for the DUO mode, an indication of a session identification of the DUO mode, one or more links for which the second request applies for, or the mode of operation that is requested to be disabled.

In an embodiment, the first request frame includes at least one of a field set to a first value to indicate the request to enable the DUO mode, one or more links for which the first request applies, the mode of operation that is requested to be enabled, and parameters corresponding to the mode of operation, an indication of a type of radio technology interference at the STA, or a type of traffic with which the DUO mode is associated.

In an embodiment, the first response frame includes at least one of an indication of a response of whether the first request frame is accepted, delayed, or rejected, a type of traffic with which the DUO mode is associated, a DUO mode identification (ID) for the DUO mode, or a link indication identifying the one or more links associated with the DUO mode.

In an embodiment, the processor is further configured to cause transmitting, to the AP, a second request frame to modify parameters associated with mode of operation.

In an embodiment, the second request frame includes at least one of one or more links for which the second request applies for, the mode of operation for which parameters are modified, or parameters to be modified, and wherein the parameters include at least one of a modification indication, an unavailability target start time indicating a specific point in time the STA will be unavailable, an unavailability duration indicating how long the STA is unavailable, a type of traffic with which the DUO mode is associated with, a DUO identification (ID) for the DUO mode, or a link indication identifying one or more links associated with the DUO mode.

In an embodiment, the processor is further configured to cause receiving, from the AP, a second response frame indicating an acceptance by the AP of the second request to modify the parameters associated with the mode of operation.

In an embodiment, the parameters to be modified include at least one of a modification indication, an unavailability target start time indicating a specific point in time the STA will be unavailable, an unavailability duration indicating how long the STA is unavailable, a type of traffic with which the DUO mode is associated with, a DUO identification (ID) for the DUO mode, or a link indication identifying one or more new links associated with the DUO mode.

In an embodiment, the processor is further configured to cause receiving, from the AP, a third frame, wherein the third fame includes a field indicating an operating mode timeout value, wherein the STA receives the first response frame from the AP within a timeout interval that starts at an end of a physical layer protocol data unit (PPDU) carrying the first request frame, and wherein the timeout interval is initialized to the operating mode timeout value indicated in the field.

An aspect of the present disclosure provides for an access point (AP) in a wireless network comprising a memory and a processor coupled to the memory, the processor configured to cause receiving, from a station (STA) associated with the AP, a first request frame to enable a mode of operation for the STA, wherein the mode of operation requested is a dynamic unavailability operation (DUO) mode associated with a duration during which the STA is unavailable, transmitting, to the STA, a first response frame indicating that the AP is ready to serve the STA in the DUO mode, transmitting, to the STA, an initial control frame (ICF) that solicits unavailability information from the STA, and receiving, from the STA, an initial control response (ICR) frame in response to the ICF, the ICR frame indicating unavailability information.

In an embodiment, the processor is further configured to cause receiving, from the STA, a second request frame to disable mode of operation, wherein the second request frame includes a field value set to a first value to indicate the request to disable the DUO mode and transmitting, to the STA, a second response frame indicating the AP is no longer serving the STA in the DUO mode in response to the second request frame.

In an embodiment, the second request frame includes at least one of an indication that the second request frame is for the DUO mode, an indication of a session identification of the DUO mode, one or more links for which the second request applies for, or the mode of operation that is requested to be disabled.

In an embodiment, the first request frame includes at least one of a field set to a first value to indicate the request to enable the DUO mode, an indication of a type of radio technology interference at the STA, a type of traffic with which the DUO mode is associated, one or more links for which the first request applies, the mode of operation that is requested to be enabled, and corresponding parameters of the mode of operation.

In an embodiment, the first response frame includes at least one of an indication of a response of whether the first request frame is accepted, delayed, or rejected, a type of traffic with which the DUO mode is associated, a DUO mode identification (ID) for the DUO mode, or a link indication identifying the one or more links associated with the DUO mode.

In an embodiment, receiving, from the STA, a second request frame to modify parameters associated with the mode of operation.

In an embodiment, transmitting, to the STA, a second response frame indicating an acceptance by the AP of the second request to modify the parameters associated with the mode of operation.

In an embodiment, the second request frame includes at least one of one or more links for which the second request applies, the mode of operation for which parameters are modified, or parameters to be modified, wherein the parameters include at least one of a modification indication, an unavailability target start time indicating a specific point in time the STA will be unavailable, an unavailability duration indicating how long the STA is unavailable, a type of traffic with which the DUO mode is associated with, a DUO identification (ID) for the DUO mode, or a link indication identifying one or more links associated with the DUO mode.

In an embodiment, the processor is further configured to cause transmitting, to the STA, a third frame, wherein the third frame includes a field indicating an operating mode timeout value, and wherein the AP transmits the first response frame within a timeout interval that starts at an end of a physical layer protocol data unit (PPDU) carrying the first request frame, wherein the timeout interval is initialized to the operating mode timeout value indicated in the field.

An aspect of the present disclosure provides for a method performed by a station (STA) in a wireless network, comprising: transmitting, to an access point (AP) associated with the STA, a first request frame to enable a mode of operation for the STA, wherein the mode of operation requested is a dynamic unavailability operation (DUO) mode associated with a duration during which the STA is unavailable, receiving, from the AP, a first response frame indicating that the AP is ready to serve the STA in the DUO mode, receiving, from the AP, an initial control frame (ICF) that solicits unavailability information from the STA, and transmitting, to the AP, an initial control response (ICR) frame in response to the ICF, the ICR frame indicating unavailability information.

In an embodiment, the method further comprises transmitting, to the AP, a second request frame to disable the mode of operation, wherein the second request frame includes a field value set to a first value to indicate the request to disable the DUO mode and receiving, from the AP, a second response frame indicating the AP is no longer serving the STA in the DUO mode in response to the second request frame.

### BRIEF DESCRIPTION OF THE DRAWINGS

FIG. 1 shows an example of a wireless network in accordance with an embodiment.

FIG. 2A shows an example of AP in accordance with an embodiment.

FIG. 2B shows an example of STA in accordance with an embodiment.

FIG. 3 shows an example of multi-link communication operation in accordance with an embodiment.

FIG. 4 shows an example ultra-wideband (UWB) system in accordance with an embodiment.

FIG. 5 shows an example illustration of a ZigBee mechanism in accordance with an embodiment.

FIG. 6 shows an example co-existence interference in accordance with an embodiment.

FIG. 7 illustrates an example process for a co-existence session in accordance with an embodiment.

FIG. 8 shows an example co-existence session in accordance with an embodiment.

FIG. 9 shows an example co-existence field format in accordance with an embodiment.

FIG. 10 shows an example co-existence element in accordance with an embodiment.

FIG. 11 shows an example beacon sub-block format in accordance with an embodiment.

FIG. 12 shows an example co-existence message transmission in accordance with an embodiment.

FIG. 13 shows an example co-existence message transmission in accordance with an embodiment.

FIG. 14 shows an example process for beacon management due to co-existence interference in accordance with an embodiment.

FIG. 15 shows an example process for a dynamic availability operation (DUO) mode in accordance with an embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

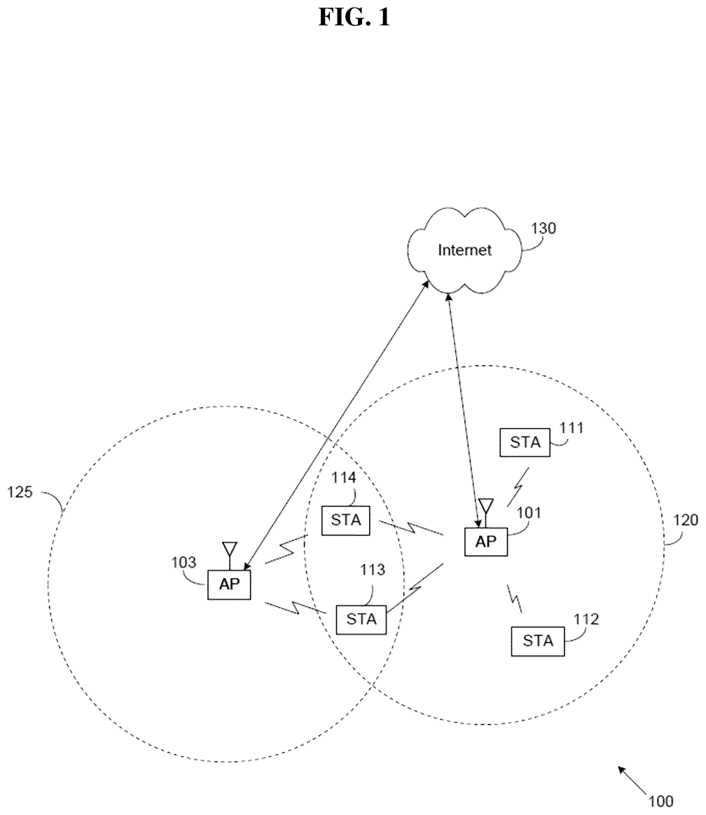

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

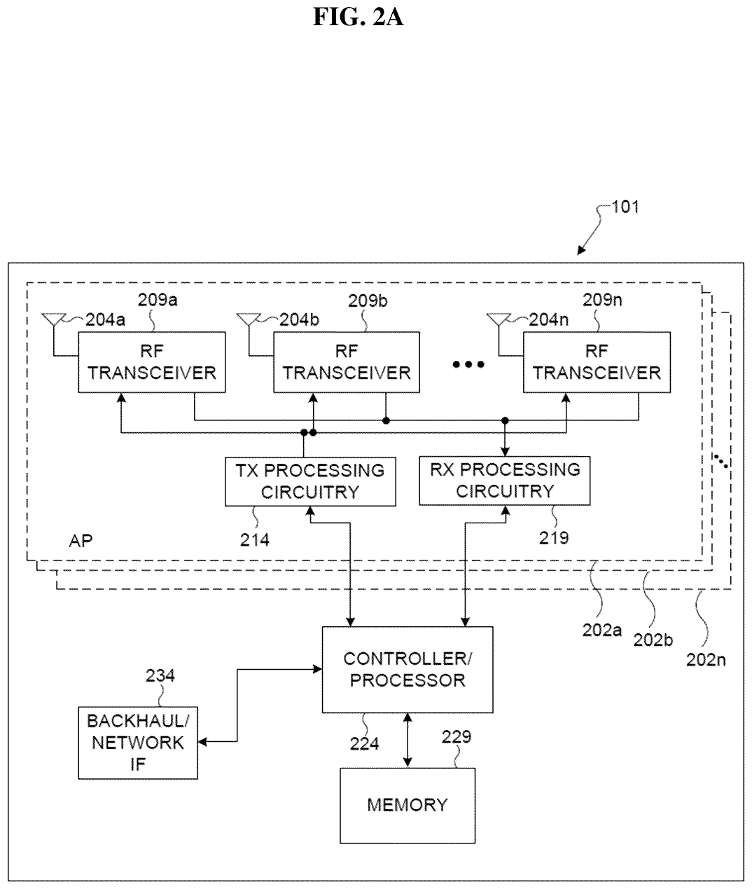

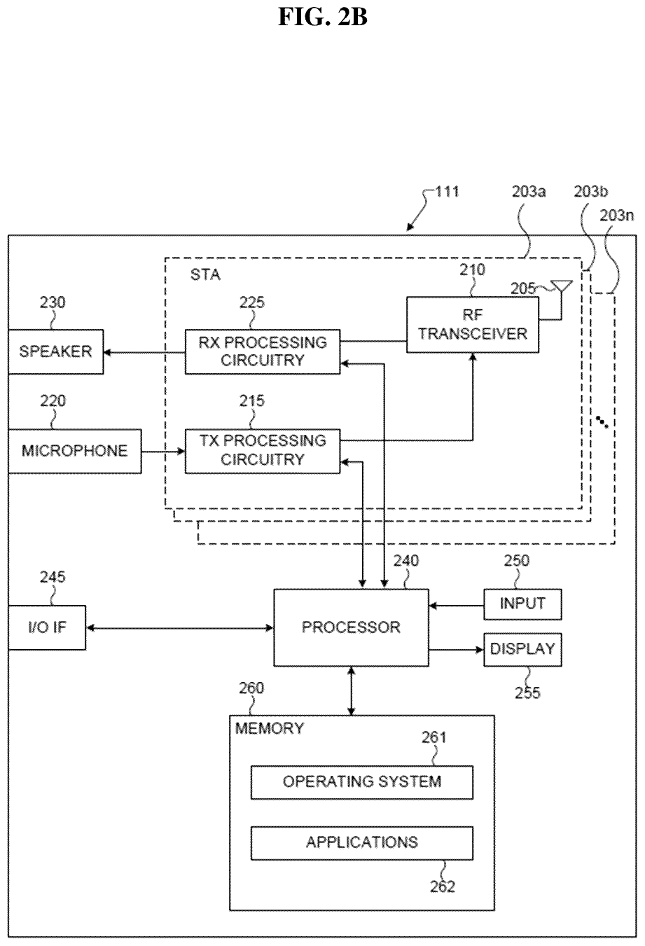

FIG. 2A shows an example of AP 101 in accordance with an embodiment. The embodiment of the AP 101 shown in FIG. 2A is for illustrative purposes, and the AP 103 of FIG. 1 could have the same or similar configuration. However, APs come in a wide range of configurations, and FIG. 2A does not limit the scope of this disclosure to any particular implementations of an AP.

As shown in FIG. 2A, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2A illustrates one example of AP 101, various changes may be made to FIG. 2A. For example, the AP 101 could include any number of each component shown in FIG. 2A. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

As shown in FIG. 2A, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2A shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

FIG. 2B shows an example of STA 111 in accordance with an embodiment. The embodiment of the STA 111 shown in FIG. 2B is for illustrative purposes, and the STAs 111-114 of FIG. 1 could have the same or similar configuration. However, STAs come in a wide variety of configurations, and FIG. 2B does not limit the scope of this disclosure to any particular implementation of a STA.

As shown in FIG. 2B, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B shows one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As shown in FIG. 2B, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 2B shows that each STA 203a-203n has a separate antenna, but each STA 203a-203n can share the antenna 205 without needing separate antennas. Each STA 203a-203n may represent a physical (PHY) layer and a lower media access control (MAC) layer.

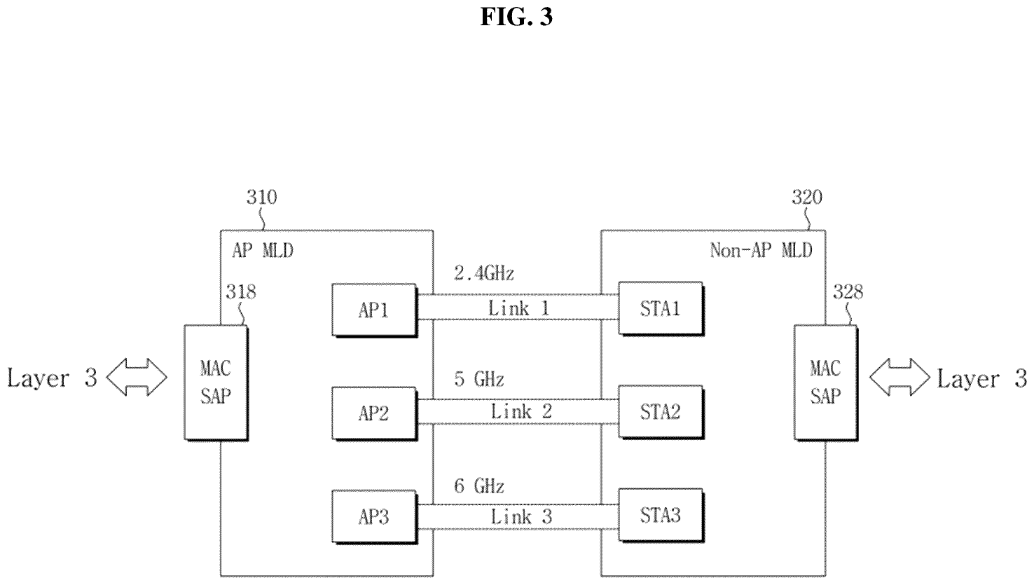

FIG. 3 shows an example of multi-link communication operation in accordance with an embodiment. The multi-link communication operation may be usable in IEEE 802.11be standard and any future amendments to IEEE 802.11 standard. In FIG. 3, an AP MLD 310 may be the wireless communication device 101 and 103 in FIG. 1 and a non-AP MLD 220 may be one of the wireless communication devices 111-114 in FIG. 1.

As shown in FIG. 3, the AP MLD 310 may include a plurality of affiliated APs, for example, including AP 1, AP 2, and AP 3. Each affiliated AP may include a PHY interface to wireless medium (Link 1, Link 2, or Link 3). The AP MLD 310 may include a single MAC service access point (SAP) 318 through which the affiliated APs of the AP MLD 310 communicate with a higher layer (Layer 3 or network layer). Each affiliated AP of the AP MLD 310 may have a MAC address (lower MAC address) different from any other affiliated APs of the AP MLD 310. The AP MLD 310 may have a MLD MAC address (upper MAC address) and the affiliated APs share the single MAC SAP 318 to Layer 3. Thus, the affiliated APs share a single IP address, and Layer 3 recognizes the AP MLD 310 by assigning the single IP address.

The non-AP MLD 320 may include a plurality of affiliated STAs, for example, including STA 1, STA 2, and STA 3. Each affiliated STA may include a PHY interface to the wireless medium (Link 1, Link 2, or Link 3). The non-AP MLD 320 may include a single MAC SAP 328 through which the affiliated STAs of the non-AP MLD 320 communicate with a higher layer (Layer 3 or network layer). Each affiliated STA of the non-AP MLD 320 may have a MAC address (lower MAC address) different from any other affiliated STAs of the non-AP MLD 320. The non-AP MLD 320 may have a MLD MAC address (upper MAC address) and the affiliated STAs share the single MAC SAP 328 to Layer 3. Thus, the affiliated STAs share a single IP address, and Layer 3 recognizes the non-AP MLD 320 by assigning the single IP address.

The AP MLD 310 and the non-AP MLD 320 may set up multiple links between their affiliate APs and STAs. In this example, the AP 1 and the STA 1 may set up Link 1 which operates in 2.4 GHz band. Similarly, the AP 2 and the STA 2 may set up Link 2 which operates in 5 GHZ band, and the AP 3 and the STA 3 may set up Link 3 which operates in 6 GHz band. Each link may enable channel access and frame exchange between the AP MLD 310 and the non-AP MLD 320 independently, which may increase date throughput and reduce latency. Upon associating with an AP MLD on a set of links (setup links), each non-AP device is assigned a unique association identifier (AID).

The following documents are hereby incorporated by reference in their entirety into the present disclosure as if fully set forth herein: i) IEEE 802.11be/D5.0, “Wireless LAN Medium Access Control (MAC) and Physical Layer (PHY) Specifications,” ii) IEEE Std 802.11-2020, “Wireless LAN Medium Access Control (MAC) and Physical Layer (PHY) Specifications,” and iii) IEEE std 802.11ax-2021, “Wireless LAN Medium Access Control (MAC) and Physical Layer (PHY) Specifications.”

As mentioned above, technologies other than Wi-Fi can be emerging or growing as well. For example, Bluetooth is a wireless technology that initially started off as a short-distance cable replacement mechanism. In some examples, Bluetooth is a short-range wireless technology used to exchange data between devices. In one embodiment, Bluetooth implements ultra-high frequency (UHF) radio waves in at least an industrial, scientific, and medical (ISM) band from 2.402 gigahertz (GHz) to 2.48 GHz. In some embodiments, a Bluetooth transmission occurs as part of a connection event. For example, during the connection event, two devices (e.g., mobile or non-mobile devices, including but not limited to, smartphones, laptops, computers, headphones, car plugs, TVs, a car stereo system, etc.) that are engaged in data transmission alternate sending data back and forth until all the data to be sent on both sides is exhausted. In some examples, one of the connected devices operates as a master and the other connected device operates as a slave. In such examples, the master device can transmit a frame (e.g., packet) to the salve device and if the slave device receives the frame, the slave device can transmit the frame back to the master device. In at least one embodiment, a connection interval refers to a duration between two connection events. In some embodiments, the connection interval can range from 7.5 milliseconds (ms) to 4 seconds(s). In at least one embodiment, an exact value of the connection duration can be negotiated between the master device and slave device to optimize their power saving while balancing latency occurred.

In some embodiments, Bluetooth transmission implements frequency hopping spread spectrum methods where a hopping sequence is used to rapidly hop between data channels. For example, Bluetooth classic is used for streaming applications (e.g., headsets) and operates on 79 radio frequency (RF) channels spaced 1 megahertz (MHz) apart. In such examples, the Bluetooth transmission can rapidly switch between multiple RF channels of the 79 RF channels. In some examples, Bluetooth Low Energy (BLE) is a power efficient variant of Bluetooth used for internet of things (IoT) applications. In some examples, the BLE operates on 40 RF channels each spaced 2 MHz apart. In at least one embodiment, for Bluetooth, some of the RF channels are reserved specifically for the purpose of advertising and others are used for secondary advertisement for data transmission. For example, Bluetooth classic includes 32 channels that are reserved for advertisement while BLE includes 3 channels that are reserved for advertisement.

However, Bluetooth and Wi-Fi follow different channel access protocols and the coexistence of Bluetooth can lead to interference with Wi-Fi transmissions. That is, while some Bluetooth transmissions are scheduled and make the interference more predictable, other Bluetooth transmissions are hard to predict in advance. Accordingly, a mechanism to react to Bluetooth interference when occurs is needed. Especially given that Bluetooth is used for a large number of applications today—e.g., used for streaming applications, sensor applications, way finding based on beaconing, etc. In some embodiments, Wi-Fi routers can include Bluetooth raidso for the purpose of finding and location awareness applications. Additionally, a user's smart phone can also be configured as a mobile AP which can utilize Bluetooth. It should be noted that while Bluetooth has primarily operated on the 2.4 GHz band, the next generation of Bluetooth technology is expected to utilize 5 GHz as well as 6 GHz bands. Thus, the interference could be worse for Wi-Fi devices or operations that utilize the 5 GHz and 6 GHz bands for communication.

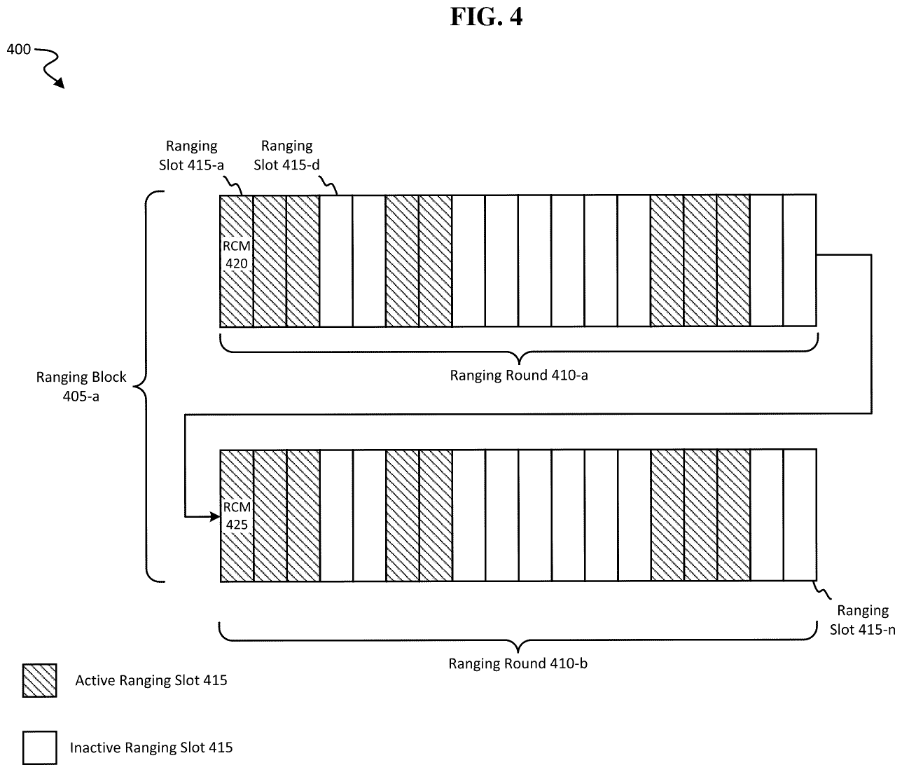

FIG. 4 shows an example scheme for an ultra-wide band (UWB) system 400. FIG. 4 illustrates a ranging block 405 in accordance with an embodiment. The ranging block 405 depicted in FIG. 4 is for explanatory and illustration purposes and FIG. 4 does not limit the scope of this disclosure to any particular implementation. In some embodiments, the ranging block 405 illustrated in FIG. 4 is used in conventional UWB solutions.

In at least one embodiment, ranging block 405 includes a ranging round 410-a and a ranging round 410-b. In at least one embodiment, each ranging round 410-a can include one or more ranging slots 415. In some embodiments, not all ranging slots 415 of the ranging round 410 arc active—e.g., some ranging slots 415 are inactive and represent a silent period in which the system 400 is not transmitting data. For example, the system 400 can transmit data or frames during ranging slot 415-a to ranging slot 415-c and stop transmitting at ranging slot 415-d.

In at least one embodiment, UWB has become popular for use cases involving indoor positioning and navigation utilizing the 6 GHz band. In some embodiments, an IEEE 802.15.4 standard has defined a block-based mode for ranging. In the block-based mode for ranging, as depicted in FIG. 4, ranging blocks 405 is divided into ranging rounds 410 and the ranging rounds 410 are further divided into ranging slots 415. In some examples, a number of ranging rounds 410 in a ranging block 405, a number of ranging slots 415 in a ranging round 410, and a duration of each ranging slots 415 is transmitted by a controller in the system 400. In such examples, the controller can transmit the information in a ranging control message (RCM) 420 to a participant device. In some examples, the RCM 420 information is for a current ranging round 410. In other embodiments, the RCM 420 information can also be used for subsequent ranging rounds 410—e.g., the RCM 420 could also apply to the ranging round 410-b. It should be noted that although ranging round 410-a and ranging round 410-b are depicted as having a same format, in other examples their format can vary. For example, ranging round 410-b can include less or more ranging rounds 410 and ranging slots 415 than compared with ranging round 410-a.

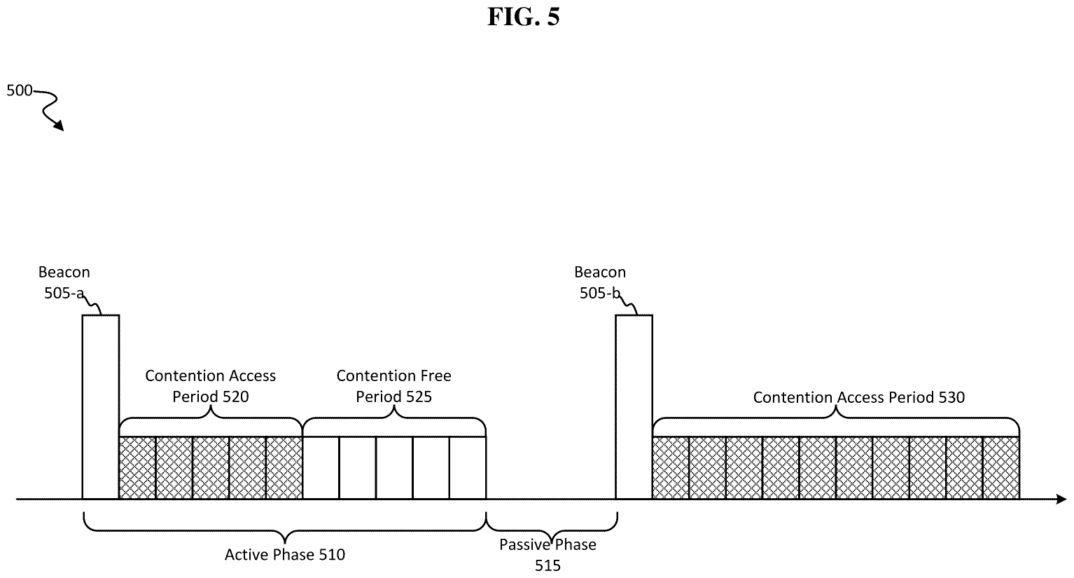

FIG. 5 illustrates an example scheme for a Zigbee system 500. FIG. 5 illustrates an access scheme for the Zigbee system 500. In some embodiments, the scheme for the Zigbee system 500 illustrated in FIG. 5 is used in conventional Zigbee solutions.

In at least one embodiment, Zigbee protocol is another technology for smart home applications. In at least one embodiment, the Zigbee protocol is based on beacon intervals—e.g., a duration between beacons 505. For example, a duration between transmitting beacon 505-a and transmitting beacon 505-b can be a first beacon interval. In some embodiments, a coordinator in ZigBee operation transmits periodic beacons 505. In such examples, each beacon 505 can be followed by the start of an active phase 510—e.g., the coordinator can transmit the beacon 505 to initiate the active phase 510. In at least one embodiment, each beacon 505 indicates a duration of the active phase 510 and a time until the next beacon frame 505. Accordingly, each beacon interval can be divided into two phases, a first phase includes the active phase 510 and starts after the beacon 505, and a second phase includes the passive phase 515 for power save. In some embodiments, the passive phase 515 can last from the end of the active phase 510 until a new beacon 505 is received. In at least one embodiment, the active phase 510 can be divided into a contention access period 520 and a contention free period 525. In at least one embodiment, a duration for each phase (e.g., for the active phase 510 or the inactive phase 515) and the beacon interval can be characterized by duration value (e.g., aBaseSlotDuration value), a beacon order (e.g., macBeaconOrder (BO)), and a frame order (e.g., macSuperframeOrder (SO)). In one example, the BO and SO values can be integer values ranging from 0 to 14. In at least one embodiment, the beacon interval can be computed as a duration (e.g., aBaseSuperframeDuration) times a multiple of two—e.g., Beacon Interval=aBaseSuperframeDuration*230. In such embodiments, the active phase 515 can be computed as the duration times a multiple of two—e.g., Active Phase=aBaseSuperframeDuration*250. In at least one embodiment, the duration (e.g., aBaseSuperframeDuration) is determined based on the duration of a slot—e.g., aBaseSuperframeDuration=16*aBaseSlotDuration.

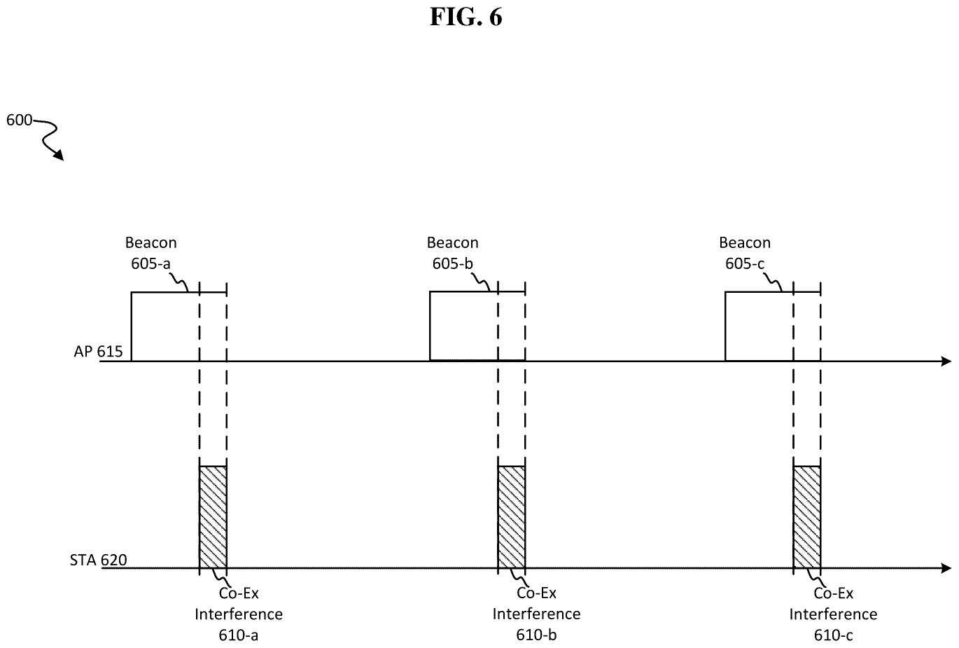

FIG. 6 illustrates co-existence interference 600 in accordance with an embodiment. In at least one embodiment, FIG. 6 illustrates a coexistence interference between an access point (AP) 615 and a station (STA) 620.

In one embodiment, coexistence interference can be periodic. For example, co-existence interference 610 can occur periodically—e.g., repeating in a predictable fashion. In one example, though, the co-existence interference 610 can coincide with a beacon 605 arrival. That is, the AP 615 can transmit beacons 605 periodically but the STA 610 can experience co-existence interference periodically during the beacon 605 reception. For example, the STA can experience co-existence interference 610-a during the reception of beacon 605-a, experience co-existence 610-b during the reception of beacon 605-b, and experience co-existence 610-c during the reception of beacon 605-c. In such embodiments, the STA 620 can fail to accurately decode the beacon 605—e.g., a portion of the beacon 605 cannot be received by the STA 620 due to co-existence interference. However, repeated requests for beacon information that is not received by STA 620 can result in large air time consumption and hurt the overall performance and efficiency of the system.

In some embodiments, the co-existence interference 610 can be a result of a nearby Bluetooth device, UWB device, or ZigBee device as described with reference to FIGS. 4 and 5. In other embodiments, the co-existence interference 610 can be due to a different type of interference.

For example, IEEE 802.11be introduced multi-link operations as a mean to enhance device performance. In such embodiments, a multi-link device (MLD) can include one or more stations (STAs) affiliated with it. Accordingly, an AP MLD can have one or more affiliated AP STAs with it and a non-AP MLD can have one or more non-AP STAs affiliated with it. During a multi-link operation, the AP MLD can transmit concurrently on more than one link. This can increase channel access probability but because multi-link operations (MLO) leverage the three bands of operation in Wi-Fi (e.g., 2.4 GHz, 5 GHZ, 6 GHZ), there can be coexistence interference.

In some examples, a mobile AP MLD is a special type of AP MLD. For example, the mobile AP MLD can be a battery powered device. In one example, the mobile AP MLD includes two links, a primary link and a non-primary link. However, mobile AP MLDS have additional constraints during their operations. For example mobile AP MLDs have a constraint of a tight synchronization between the transmission and reception on the primary and non-primary link. In one embodiment, an AP STA affiliated with the mobile AP MLD can initiate a physical layer protocol data unit (PPDU) transmission to its associated non-AP STA of the non-AP MLD on the non-primary link if the STA affiliated with the same MLD on the primary link is also initiating a PPDU as a transmission opportunity (TXOP) holder with a same start time. In at least one embodiment, the same constraint is also followed by the non-AP MLD side for a non-AP MLD associated with a Mobile AP MLD. In some embodiments, there can be coexistence interference for the mobile AP MLD.

In at least one embodiment, for a number of applications described above, one or more of non-Wi-Fi technology (e.g., non-IEEE 802.11 technology) can exist simultaneously on a wireless device—e.g., a mobile smartphone can include both Wi-Fi and Bluetooth capabilities. However, this can cause self-interference. That is, co-located non-Wi-Fi radio technology does not follow the same channel access and transmission protocols as Wi-Fi technology radios. In some embodiments, the self-interference can affect an AP MLD's ongoing transmissions and receptions as a signal-to-interference-plus-noise-ratio (SINR) gets reduced and performance is degraded. In some examples, a device may not be able to transmit Wi-Fi frames while another coexisting radio technology is on and active within the device. For example, a device may include an antenna utilized by both Wi-Fi and Bluetooth. In some embodiments, if the device has the antenna utilized for Bluetooth, the device can be unavailable for Wi-Fi frame exchanges, and any frames sent during that time lead to failure and hurt the performance of the deice.

In at least one embodiment, the non-Wi-Fi technology radio can be periodic—e.g., music streaming over Bluetooth can be approximated as a periodic traffic stream). In other examples, the non-Wi-Fi technology radio can be aperiodic or scheduled—e.g., management/control/feedback message transmission in Bluetooth.

In some embodiments, an AP can enable co-existence mechanisms to avoid coexistence issues from impacting the Wi-Fi frame transmissions. For example, an AP can transmit an initial control frame (ICF) (e.g., a modified buffer status report poll (BSRP) frame) and receive an initial control response (ICR) (e.g., a modified multi-STA block acknowledgment (BA) frame) to start communications. However, the AP would need information about when to transmit the frames. That is, in lieu of using request to send (RTS) and clear to send (CTS) mechanisms, the AP can attempt to utilize the ICF and ICR procedure, but the AP may be unaware of the activity of coexisting radios on the STA side. In such embodiments, the STA may be the only device capable of determining the availability or use of the non-Wi-Fi technology radios. Accordingly, a framework and procedure by which an AP can determine if it can activate coexistence mechanisms for a particular STA experience coexistence interference is desired.

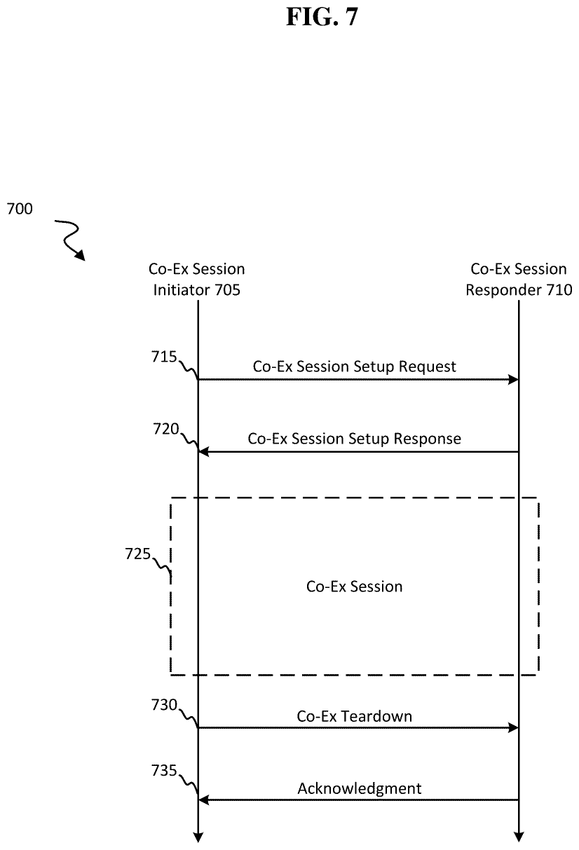

FIG. 7 shows an example co-existence session process 700 in accordance with an embodiment. Although one or more operations are described or shown in a particular sequential order, in other embodiments the operations may be rearranged in a different order, which may include performance of multiple operations in at least partially overlapping time periods. It should be noted that the co-existence session, co-existence mode, or the co-existence operations can be referred to as a dynamic unavailability operation (DUO).

In at least one embodiment, process 700 is performed by a co-existence session initiator 705 and a co-existence session responder 710. In one embodiment, the co-existence session initiator 705 is an example of a station (STA) and the co-existence session responder 710 is an example of an access point (AP). That is, in one embodiment, the STA can setup a co-existence session with an AP. In other embodiments, the co-existence session initiator 705 is an example of an AP and the co-existence session responder 710 is an example of an STA. In some embodiments, both the co-existence session initiator 705 and the co-existence session responder 710 can be peers—e.g., both STA or AP devices.

At operation 715, the co-existence session initiator 705 can transmit a co-existence session setup request to the co-existence session responder 710. In at least one embodiment, the co-existence session setup request can include one or more parameters that characterize or define a co-existence session. In at least one embodiment, the co-existence session setup request can include the information indicated in Table 1:

TABLE 1

| Information | |
|---|---|
| Item | Description |
| Co-Existence | One or more information items that can indicate if the co-existence session |
| constraint | initiator 705 has a co-existence constraint. In an example, a bit or flag |
| indication | present in the co-existence session setup request can be set to a certain value |
| | (e.g., one ‘1’) to indicate the presence of the co-existence constraint. In some |
| | examples, transmitting the co-existence session setup request itself can |
| | implicitly imply the presence of the co-existence constraint by the act of the |
| | transmission of the setup request—e.g., the co-existence constraint is |
| | implicitly indicated by the transmission of the set-up request |
| Co-Existence | One or more information items that can indicate a duration for which the co- |
| session | existence session lasts. For example, the co-session existence initiator 705 |
| duration | can indicate a number (e.g., remaining number) of target beacon |
| | transmission time (TBTT) from a current TBTT. |
| Add indication | One or more information items that can indicate the co-session initiator 705 |
| | wants to initialize a co-existence session. In at least one embodiment, the |
| | ‘add indication’ is indicated by a bit/flag/encoding that can be set to a certain |
| | value (e.g., to one ‘1’). |
| Co-Existence | One or more information items that indicate the type of co-existence |
| type | interference—e.g., indicate the type of co-existence radio. For example, the |
| | co-session initiator 705 can indicate a Bluetooth radio or a peer-to-peer |
| | (P2P) system causing interference. |
| Traffic type | One or more information items that can indicate a type of traffic for which |
| | the co-existence constraint can apply to. For example, a traffic identifier |
| | (TID) bitmap can indicate the set of TIDs for which the co-existence session |
| | applies to or a stream classification service (SCS) identification (ID) to |
| | indicate the SCS sessions setup, etc. |
| Link indication | One or more information items that can indicate a link (e.g., links) of the co- |
| | existence session responder 710 (e.g., an AP MLD) with which the co- |
| | existence session initiator 705 (e.g., non-AP MLD) can be associated to and |
| | to which link(s) the co-existence session or unavailability constraint can |
| | apply to. For example, the co-existence session setup request can include a |
| | link ID, a link ID list, or a link ID bitmap to indicate the links. |

In at least one embodiment, the information items listed in Table 1 can be transmitted together or separately as part of the co-existence session setup request. In some embodiments, the information items listed in Table 1 can be included or transmitted as part of an existing IEEE 802.11 frame, element, field, or subfield. In other embodiments, the information items listed in Table 1 can be transmitted in a newly defined frame, element, field, or subfield.

At operation 720, the co-existence session responder 710 can transmit a co-existence session setup response to the co-existence session initiator 705. In at least one embodiment, the co-existence session responder 710 can respond based on receiving the co-existence session setup request. That is, the co-existence session responder 710 can receive the co-existence session setup request, process the message, and then generate the co-existence session setup response. In at least one embodiment, the co-existence session responder 710 can indicate whether it accepts or rejects the co-existence session initiator 705 setup request. If the setup request is rejected by the co-existence session responder 710, the co-existence session initiator 705 can make another setup request at a future time. In other embodiments, the co-existence session initiator 705 can transmit the setup request based on a timeout period. That is, the timeout period can refer to a period of time within which a response from the co-existence session responder 710 can arrive. In such embodiments, if the co-existence session responder 710 does not respond within the timeout period, the co-existence session initiator 705 can make another co-existence session setup request at a future time.

In some embodiments, the co-existence session responder 710 can accept the co-existence session initiator 705 request to activate the co-existence session. In such embodiments, if the co-existence session initiator 705 receives the response within the timeout period, the co-existence session can begin following an acknowledgement by the co-session initiator 705 of the acceptance by co-existence session responder 710. In at least one embodiment, the timeout value can be fixed based on the 802.11 family of standards. In other embodiments, the co-existence session responder 710 can advertise (e.g., notify) the co-existence session initiator 705 of the timeout value. In such embodiments, the co-existence session responder 710 can notify the co-existence session initiator 705 of the timeout value in one or more frame the co-existence session responder 710 transmits—e.g., transmitted in management frames such as beacons, probe response, association, (reassociation), etc. In some embodiments, the co-existence session responder 710 can transmit the timeout value in a common information field of a basic multi-link element. In other embodiments, the co-existence session responder 710 can transmit the timeout value in an ultra-high reliability (UHR) operation element.

In at least embodiment, if the setup request is rejected, the co-existence session setup response can include an additional time value or period of time before which the co-existence session initiator 705 cannot make another co-existence session setup request.

In at least one embodiment, the co-existence session responder 710 can indicate a time for processing the co-existence session setup request in the co-existence session setup response. In addition to the information described herein, the response message can include the information indicated in Table 2:

TABLE 2

| Information | |
|---|---|
| Item | Description |
| Response | One or more information items that can indicate a response of the co- |
| Indication | existence session responder 710. Example responses can be acceptance, |
| | rejection, indicate a delay, etc. |
| | In some examples, the response indication is provided via a status code. |
| | In other examples, transmission of the response frame by co-existence |
| | session responder 710 indicates acceptance (e.g., the acceptance is implied) |
| | In some embodiments, the response indication can be in a form of a bit/flag |
| | that is set to a predetermined value (e.g., one ‘1’) to make an indication of |
| | acceptance and set to another predetermined value (e.g., zero ‘0’) to indicate |
| | otherwise (e.g. indicate rejection). |
| Co-Existence | One or more information items that can indicate a duration for which the co- |
| Session | existence session can last. For example, the co-session existence responder |
| Duration | 710 can indicate a number (e.g., remaining number) of target beacon |
| | transmission time (TBTT) from a current TBTT. |
| Traffic Type | One or more information items that can indicate a type of traffic for which |
| | the co-existence constraint can apply to. For example, a traffic identifier |
| | (TID) bitmap can indicate the set of TIDs for which the co-existence session |
| | applies to or a stream classification service (SCS) identification (ID) to |
| | indicate the SCS sessions setup, etc. |
| Co-Existence | One or more information items that can define or characterize a co-existence |
| Session | session—e.g., the information items can include a session identification that |
| Indicator | can be used by the co-existence session initiator 705 to modify the co- |
| | existence session. |
| Link Indication | One or more information items that can indicate a link (e.g., links) of the co- |
| | existence session responder 710 (e.g., an AP MLD) with which the co- |
| | existence session initiator 705 (e.g., non-AP MLD) can be associated to and |
| | to which link(s) the co-existence session or unavailability constraint can |
| | apply to. For example, the co-existence session setup request can include a |
| | link ID, a link ID list, or a link ID bitmap to indicate the links. |

In at least one embodiment, the information items listed in Table 2 can be transmitted or separately as part of the co-existence setup response. In some embodiments, the information items listed in Table 2 can be included or transmitted as part of an existing IEEE 802.11 frame, element, field, or subfield. In other embodiments, the information items listed in Table 2 can be transmitted in a newly defined frame, element, field, or subfield.

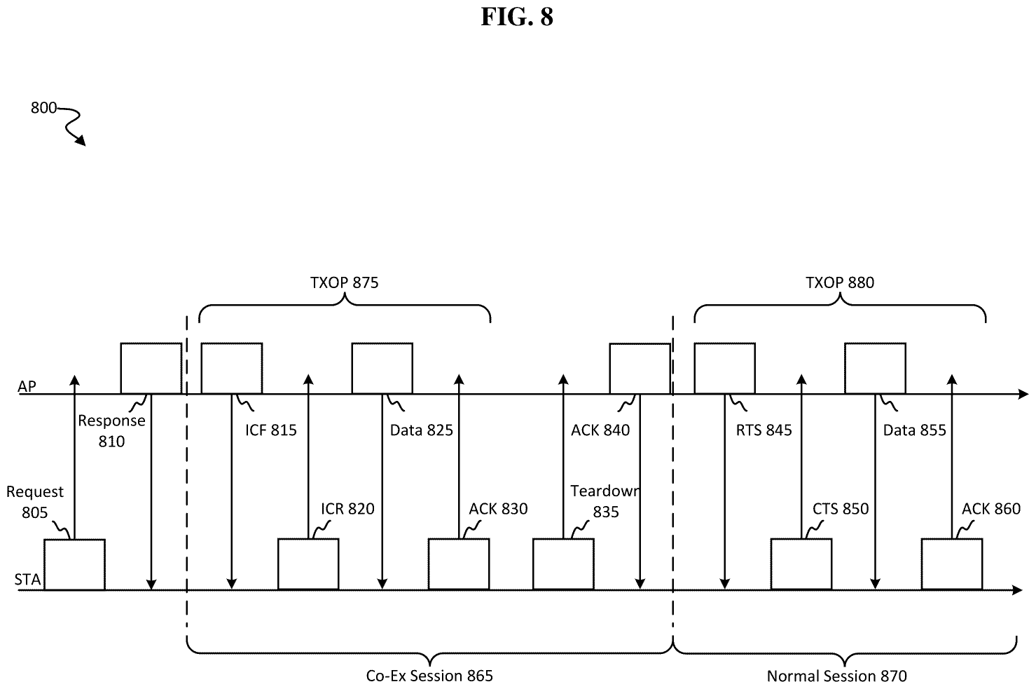

At operation 725, the co-existence session responder 710 can take actions to activate the co-existence session 725. In some embodiments, the co-existence session responder 710 can utilize co-existence mechanisms during the co-existence session. In one embodiment, the co-existence session responder 710 can take co-existence related actions for its frame exchange with the co-existence session initiator 705. For example, the co-existence session responder 710 can begin frame transmissions to the co-existence session initiator 705 with an initial control frame (ICF) during the co-existence session. In such embodiments, the co-existence session responder 710 can utilize the ICF to request co-existence related feedback from the co-existence session initiator 705. Additional details regarding the co-existence session are described with reference to FIG. 8.

In at least one embodiment, during the co-existence session (e.g., during operation 725), the co-existence session initiator 705 can modify one or more co-existence session parameters. In such embodiments, the co-existence session initiator 705 can transmit a co-existence session modification message. In some embodiments, the co-existence session initiator 705 can transmit a co-existence session message that includes at least one or more of the following items indicated in Table 3:

TABLE 3

| Information Items | Description |
|---|---|
| Modify Indication | One or more information items that can indicate a need to modify the co- |
| | existence session parameters—e.g., the indication could include a reason |
| | code |
| Co-existence | One or more information items that can indicate a start time for the co- |
| Session Start Time | existence session |
| Co-existence | One or more information items that can indicate a duration for which the |
| Session Duration | co-existence session can last. For example, the co-session existence |
| | responder 710 can indicate a number (e.g., remaining number) of target |
| | beacon transmission time (TBTT) from a current TBTT. |
| Traffic Type | One or more information items that can indicate a type of traffic for which |
| | the co-existence constraint can apply to. For example, a traffic identifier |
| | (TID) bitmap can indicate the set of TIDs for which the co-existence |
| | session applies to or a stream classification service (SCS) identification |
| | (ID) to indicate the SCS sessions setup, etc. |
| Co-existence | One or more information items that can define or characterize a co- |
| Session Indicator | existence session—e.g., the information items can include a session |
| | identification that can be used by the co-existence session initiator 705 to |
| | modify the co-existence session. |
| Link Indication | One or more information items that can indicate a link (e.g., links) of the |
| | co-existence session responder 710 (e.g., an AP MLD) with which the co- |
| | existence session initiator 705 (e.g., non-AP MLD) can be associated to |
| | and to which link(s) the co-existence session or unavailability constraint |
| | can apply to. For example, the co-existence session setup request can |
| | include a link ID, a link ID list, or a link ID bitmap to indicate the links. |

In at least one embodiment, the information items listed in Table 3 can be transmitted or separately as part of the co-existence setup response. In some embodiments, the information items listed in Table 3 can be included or transmitted as part of an existing IEEE 802.11 frame, element, field, or subfield. In other embodiments, the information items listed in Table 3 can be transmitted in a newly defined frame, element, field, or subfield.

At operation 730, the co-existence session initiator 705 can transmit a co-existence session teardown message to the co-existence session responder 710. That is, in some embodiments, the co-existence session initiator 705 can terminate its co-existence session with the co-existence session responder 710. In such embodiments, the co-existence session initiator 705 can transmit the co-existence teardown message to initiate termination. In at least one embodiment, the co-existence session initiator 705 can transmit a co-existence session teardown message (e.g., a co-existence session termination message) that includes at least one or more of the following items indicated in Table 4:

TABLE 4

| Information Items | Description |
|---|---|
| Co-existence | One or more information items that can define or characterize a co- |
| session indicator | existence session—e.g., the information items can include a session |
| | identification that can be used by the co-existence session initiator 705 to |
| | modify the co-existence session. |
| Termination | One or more information items that can indicate the termination of the co- |
| Indication | existence session—e.g., a reason code. In some examples, the termination |
| | indication can be a bit or flag that can be set to a predetermined value (e.g., |
| | to zero ‘0’) to make the indication. |
| Link Indication | One or more information items that can indicate a link (e.g., links) of the |
| | co-existence session responder 710 (e.g., an AP MLD) with which the co- |
| | existence session initiator 705 (e.g., non-AP MLD) can be associated to and |
| | to which link(s) the co-existence session or unavailability constraint can |
| | apply to. For example, the co-existence session setup request can include a |
| | link ID, a link ID list, or a link ID bitmap to indicate the links. |
| | In some examples, the link indication can be viewed as a termination of the |
| | co-existence session (e.g., termination of the unavailability setup) for some |
| | links but a continuation of some other links (e.g., the link indication keeps |
| | the other link active). For example, if in the original co-existence session |
| | setup request the co-existence session initiator 705 transmitted had a link |
| | indication for link 1, link 2, and link 3, the co-existence session initiator |
| | 705 can later terminate any one link 1, link 2, and/or link 3—e.g., the co- |
| | existence session initiator 705 can terminate the co-existence session for |
| | link 2 but retain the co-existence session for link 1 and link 3. Accordingly, |
| | the link indication in a teardown message can indicate links to be retained |
| | or links for which the co-existence session can be terminated. |

In at least one embodiment, the information items listed in Table 4 can be transmitted or separately as part of the co-existence teardown message. In some embodiments, the information items listed in Table 4 can be included or transmitted as part of an existing IEEE 802.11 frame, element, field, or subfield. In other embodiments, the information items listed in Table 4 can be transmitted in a newly defined frame, element, field, or subfield.

At operation 735, the co-existence session responder 710 can transmit an acknowledgment to co-existence session initiator 705. In at least one embodiment, the co-existence session responder 710 can accept the request to terminate the co-existence session. In such embodiments, the co-existence session responder 710 can terminate the co-existence session—e.g., stop utilizing the ICF frames and transmitting with RTS and CTS procedures.

FIG. 8 illustrates an example co-existence session scheme 800. In at least one embodiment, the operations illustrated in FIG. 8 are performed by an access point (AP) and a station (STA). In at least some embodiments, the AP can be an example of co-existence session responder 710 and the STA can be an example of co-existence session initiator 705 as described with reference to FIG. 7. Although one or more operations are described or shown in a particular sequential order, in other embodiments the operations may be rearranged in a different order, which may include performance of multiple operations in at least partially overlapping time periods

In at least one embodiment, before request 805 (e.g., before the STA transmits a request 805), the STA can turn on or activate Bluetooth (e.g., or another type of interfering radio technology present in or around the STA). In some embodiments, the STA is not transmitting or receiving data frames over a Wi-Fi network prior to transmitting the request 805. In such embodiments, though, the Bluetooth (e.g., or other interfering radio technology) can be exchanging basic management or control frames. Accordingly, the STA can setup a co-existence session with the AP to ensure the STA transmission can be adapted to avoid interference from the co-existence (e.g., from Bluetooth or the other interfering radio technology). For example, the STA can initiate the co-existence session by transmitting a request 805 to the AP. In some embodiments, the request 805 can include one or more information items described with reference to Table 1—e.g., for example, the STA can indicate at least one of the following: a co-existence constraint (e.g., the activation of the interfering radio technology), a duration of the co-existence session, indicate a type of co-existence interference (e.g., Bluetooth interference), indicate a traffic type, or indicate a link.

In at least some embodiments, after receiving the request 805, the AP can process the request 805 and transmit a response 810 to the STA. In at least one embodiment, the response 810 can include one or more information items described with reference to Table 2—e.g., for example, the AP can indicate at least one of the following in the response 810: a response indication (e.g., whether the request 805 is accepted, rejected, or delayed), a co-existence duration, a traffic type, a co-existence session indicator, and a link indication. In at least one embodiment, the STA can acknowledge the response 810 from the AP. In at least one embodiment, the AP can initiate a co-existence session 865 as a result of accepting the request 805 and acknowledging the request in the response 810.

For example, during the co-existence session 865, the AP and STA can communicate via an initial control frame (ICF) and an initial control response (ICR) frame. In one embodiment, during the co-existence session 865, the STA can win a transmission opportunity TXOP—e.g., win TXOP 875. During the TXOP 875, the AP can transmit an initial control frame (ICF) 815 to the STA as part of the co-existence session 865. In at least one embodiment, the ICF 815 requests co-existence session related feedback from the STA.

In one embodiment, the STA can transmit an initial control response (ICR) frame 820 in response to the ICF 815 received from the AP. In at least one embodiment, the AP and STA can communicate information with each other after the exchange of the ICF 815 and ICR 820.

For example, after receiving the ICR 820, the AP can transmit data 825 to the STA during the TXOP 875. In such embodiments, the STA can acknowledge receipt of the data 825 with an acknowledgement message 830.

In at least one embodiment, at some point after the TXOP 875 but during the co-existence session 865, the STA can deactivate or turn off the Bluetooth radio (e.g., deactivate the interfering radio technology). For example, a user of the STA can deactivate or turn off Bluetooth. In such embodiments, the STA can begin a teardown of the co-existence session 865. It should be noted that although it the teardown is shown after the TXOP 875 period, the STA can tear down the co-existence session anytime during the co-existence session 865. In some embodiments, the STA can also modify the co-existence session with a co-existence modification message including one or more information items indicated in Table 3—e.g., the STA can indicate at least one of the following: a need to modify the co-existence session, indicate a co-existence session start time, indicate a co-existence session duration, a traffic type, a co-existence session indictor, or a link indication.

In embodiments the STA determines to teardown the co-existence session 865, the STA can transmit a teardown message 835. In at least one embodiment, the teardown message 835 can include one or more information items indicated in Table 4—e.g., the STA can transmit the tear down message including at least one of the following information items: a co-existence session indicator, a termination indication, or a link indication.

In at least one embodiment, the AP can receive the teardown message 835, process the teardown message 835, and transmit an acknowledgement 840 to the STA. In such embodiments, the acknowledgement 840 can indicate the AP accepts the teardown request and is terminating the co-existence session 865. In at least one embodiment, the AP can terminate the co-existence session 865 by returning to normal data transmission protocols. For example, the AP can tear down the co-existence session 865 and the AP and STA can transition into a normal session 870.

In at least one embodiment, during the normal session 870, the AP and STA can communicate with one another using return to send (RTS) and clear to send (CTS) protocols. For example, during the normal session 870, the AP can initiate by transmitting a return to send (RTS) 845 to the STA during a TXOP 880—e.g., the STA can win the TXOP 880 period and exchange data with the AP during the TXOP 880 period.

In some embodiments, the STA can receive the RTS 845, process the RTS 845, and respond with a CTS 850. Upon receiving the CTS 850, the AP can begin data transmission. In such embodiments, the AP can transmit data 855 during the TXOP 880. In at least one embodiment, the STA can receive data 855 and transmit an acknowledgement 860 to the AP acknowledging receipt of data 855. Accordingly, the AP can transition to a co-existence session 865 when there is a co-existence interference present (e.g., as initiated by the STA) and exchange data starting with the ICF and ICR frames and otherwise operate in a normal session 870 and exchange data starting with RTS and CTS frames.

It should be noted that although FIG. 8 illustrates explicitly setting up the co-existence session 865 (e.g., via the exchange of the request 805 and the response 810), the co-existence session setup can also be done implicitly. For example, the STA can set up a peer-to-peer (P2P) target wake time (TWT) with the AP—e.g., a P2P communication using the TWT protocol within the wireless network. In some embodiments, the STA can setup the P2P TWT with the AP to indicate unavailability. In such embodiments, an explicit co-existence session setup may not occur. Instead, the co-existence session setup can be considered implicit. In at least one embodiment, when the co-existence session is implicit via the P2P TWT, a teardown of the co-existence session can also be implicit. For example, tearing down the P2P TWT can be considered an implicit teardown of the co-existence session.

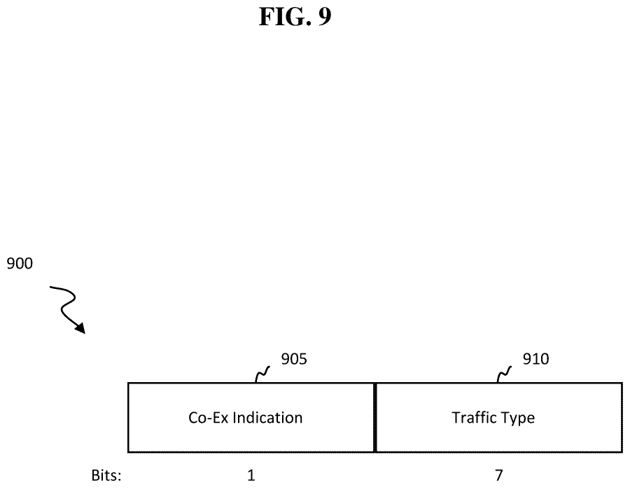

FIG. 9 illustrates an example co-existence information field 900 utilized for co-existence sessions in accordance with an embodiment herein. The format depicted in FIG. 9 is for explanatory purposes only. FIG. 9 does not limit the scope of this disclosure to any particular embodiment. Other formats and naming conventions for the fields of co-existence information field 900 are possible.

In at least one embodiment, the co-existence information field 900 can include a co-existence indication 905 and a traffic type 910. In at least one embodiment, the co-existence indication 905 can be a bit set to one ‘1’ to indicate that a station (STA) intends to start a co-existence session. In at least one embodiment, the co-existence session indication 905 can be an example of a co-existence session indicator as described with reference to Table 2, Table 3, and Table 4.

In at least one embodiment, traffic type 910 can include information about the traffic type. In at least one embodiment, the traffic type 910 can be an example of a traffic type described with reference to Tabel 1, Table 2, and Table 3. For example, the traffic type 910 can indicate a traffic identifier (TID), a stream classification service (SCS) identification (ID) to indicate the SCS sessions setup, etc., for which the co-existence session/mode is being used. In some embodiments, the traffic type 910 field is absent or reserved.

In other embodiments, the co-existence information can be exchanged via management frames. For example, the co-existence information can be exchanged via action frames, association request frames, etc. In such embodiments, the management frame including the co-existence information can indicate at least one of the following information items as shown in Table 5:

TABLE 5

| Information Items | Description |
|---|---|
| Cateogry Field | An information item that describes the |
| | category field |
| UHR Action Field | An information item that describes the action |
| | field value—e.g., a value that indicates the |
| | action frame. |
| Reference | An information item that can serve as a |
| Information | reference to a particular request message. In |
| | that, a responder can use a same value in the |
| | response frame to indicate that it is a response |
| | to a particular frame (e.g., to the action frame |
| | including the request). In some embodiments, |
| | the reference information can be a dialog |
| | token. |
| Co-Ex information | An information item that can contain |
| field/element | information that is useful for co-existence |
| | session setup, modification, and/or |
| | termination. |

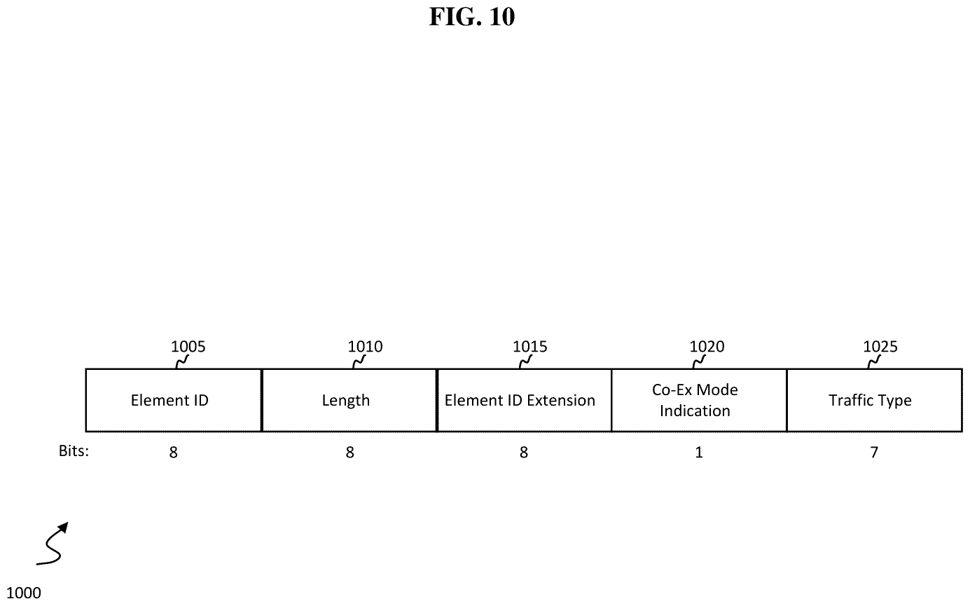

FIG. 10 illustrates an example co-existence session information element 1000 utilized for a co-existence session in accordance with an embodiment. The format depicted in FIG. 10 is for explanatory purposes only. FIG. 10 does not limit the scope of this disclosure to any particular embodiment. Other formats and naming conventions are for the fields of co-existence information element 1000 are possible.

In at least one embodiment, the co-existence information element 1000 can include an element identification 1005, a length 1010, an element identification extension 1015, a co-existence session indication 1020, and a traffic type 1025. In at least one embodiment, element ID 1005 can indicate a specific type of information element present in the co-existence information element 1000—e.g., the element ID 1005 can indicate the information element is a co-existence information element 1000. In one embodiment, the length 1010 indicates a length of the element ID extension 1015, the co-existence mode indication 1020, and the traffic type 1025. In at least one embodiment, the element ID extension 1015 can include element specific information. In one embodiment, the co-existence indication 905 can be a bit set to one ‘1’ to indicate that a station (STA) intends to start a co-existence session. In at least one embodiment, the co-existence session indication 905 can be an example of a co-existence session indicator as described with reference to Table 2, Table 3, and Table 4. In one embodiment, the traffic type 1025 can include information about the traffic type. In at least one embodiment, the traffic type 1025 can be an example of a traffic type described with reference to Table 1, Table 2, and Table 3. For example, the traffic type 1025 can indicate a traffic identifier (TID), a stream classification service (SCS) identification (ID) to indicate the SCS sessions setup, etc., for which the co-existence session/mode is being used. In some embodiments, the traffic type 1025 field is absent or reserved.

In at least one embodiment, the co-existence information element 1000 can be present in a management frame when a station (STA) initiates a setup, a modification, or a termination of the co-existence session/mode. That is, when the STA wants to enable the co-existence session, the STA can transmit a management frame to the AP including the co-existence information element 1000 with the co-existence mode indication 1020 bit set to one ‘1.’ Similarly, if the STA wants to disable or deactivate the co-existence session or mode, the STA can transmit a management frame to the AP including the co-existence information element 1000 with the co-existence indication bit 1020 set to zero ‘0.’

In at least some embodiments, an AP can receive a management frame including the co-existence information element 1000. In such embodiments, the AP can process the message and transmit a response frame. In at least one embodiment, the response frame can also be included in a management frame that includes the co-existence information element 1000. In at least one embodiment, the AP can transmit the response management frame to the STA including the co-existence information element 1000 with the co-existence mode indication 1020 bit set to one ‘1’ indicating that the AP has accepted the STA request. In other embodiments, the AP can transmit a response frame in a management frame including the co-existence information element 1000 with the co-existence mode indication 1020 bit set to zero ‘0’ to the STA to indicate the AP has terminated the co-existence session/mode.

In at least one embodiment, the AP can respond to a co-existence session request by the STA within a timeout period (e.g., within a timeout value) of receiving the request frame. In at least one embodiment, if the AP fails to respond within the timeout period, the STA can attempt to transmit another co-existence session request frame at a later time or consider that the AP has not accepted the STA's co-existence session request—e.g., the STA can take the lapse of the timeout period as a rejection by the AP.

In at least one embodiment, the STA can initiate or activate the co-existence session mode at a time of associating with an AP. In at least one embodiment, the co-existence mode can be transferred as part of a context transfer during roaming. In some embodiments, the co-existence session setup can be done via a block acknowledgment setup. In such embodiments, the setup request and the response can be carried via an add block acknowledgement (ADDBA) request/response message exchange and the teardown message can be carried via a delete block acknowledgement (DELBA) message.

In at least one embodiment, the co-existence session can be setup by an AP with an STA—e.g., the co-existence session initiator 705 can be an example of an AP and the co-existence responder 710 can be an example of an STA. In some embodiments, the co-existence session is set up between peers—e.g., between APs or between STAs. In at least one embodiment, the co-existence session can be referred to as a co-existence mode, an ICF-ICR feedback mode, a dynamic unavailability operation mode, etc. That is, the co-existence session or mode can be the same as, be referred to as, or perform the same operations as a dynamic unavailability operation (DUO).

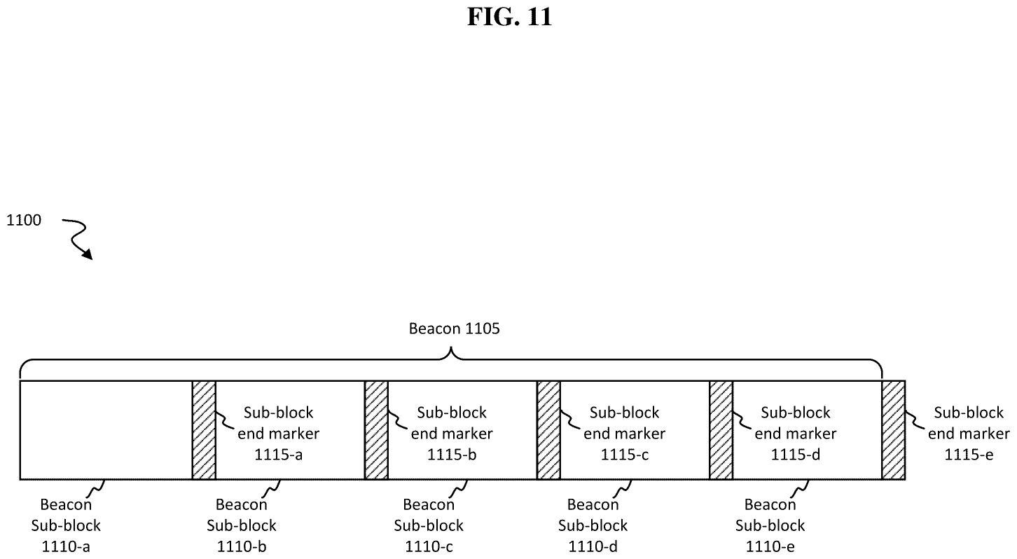

FIG. 11 illustrates an example beacon sub-block format 1100 in accordance with an embodiment. The format depicted in FIG. 11 is for explanatory purposes only. FIG. 11 does not limit the scope of this disclosure to any particular embodiment. Other formats and naming conventions for the fields of co-existence information field 1100 are possible.

In at least one embodiment, beacon sub-block format 1110 includes a beacon frame 1105. In at least one embodiment, the beacon frame 1105 is a management frame that includes information about a network. In at least one embodiment, the beacon frame 1105 can provide a timing signal to one or more STAs. As described with reference to FIG. 6, when there is co-existence interference, an STA may receive a part or none of the beacon frame 1105. Accordingly, the beacon sub-block format 1110 includes a beacon frame 1105 with one or more beacon sub-blocks 1110 each including a sub-block end marker 1115. It should be noted that a number of beacon sub-blocks 1110 illustrated in FIG. 11 are for illustration purpose only and is not limiting on the present disclosure—e.g., the beacon 1105 can include any number of beacon sub-blocks 1110. In at least one embodiment, a number of beacon sub-blocks 1110 is based on the AP or based on a value defined by the 802.11 family of standards.

In at least one embodiment, each sub block-marker 1115 can indicate whether a beacon frame 1105 is correctly decoded up to that point. That is, because the beacon 1105 includes multiple beacon sub-blocks 1110, the STA can determine how much of the beacon 1105 is decoded and received before being interfered with—e.g., before a co-existence interference interferes with reception of the beacon 1105.

For example, an STA can experience co-existence interference at a time after receiving beacon sub-block 1110-d—e.g., another technology radio such as Bluetooth can be activated by the STA after receiving the sub-block 1110-d. In such embodiments, the STA can recognize that is has received and decoded beacon sub-block 1110-d based on receiving and decoding the sub-block end marker 1115-d. Additionally, the STA can recognize it never received additional beacon sub-blocks after 1110-d based on not receiving the sub-block end marker 1115-c. Accordingly, by using the beacon sub-block format 1100, the STA can determine which portion of the beacon frame 1105 is not received (e.g., beacon sub-block 1110) and request transmission of the portions not received from the AP.

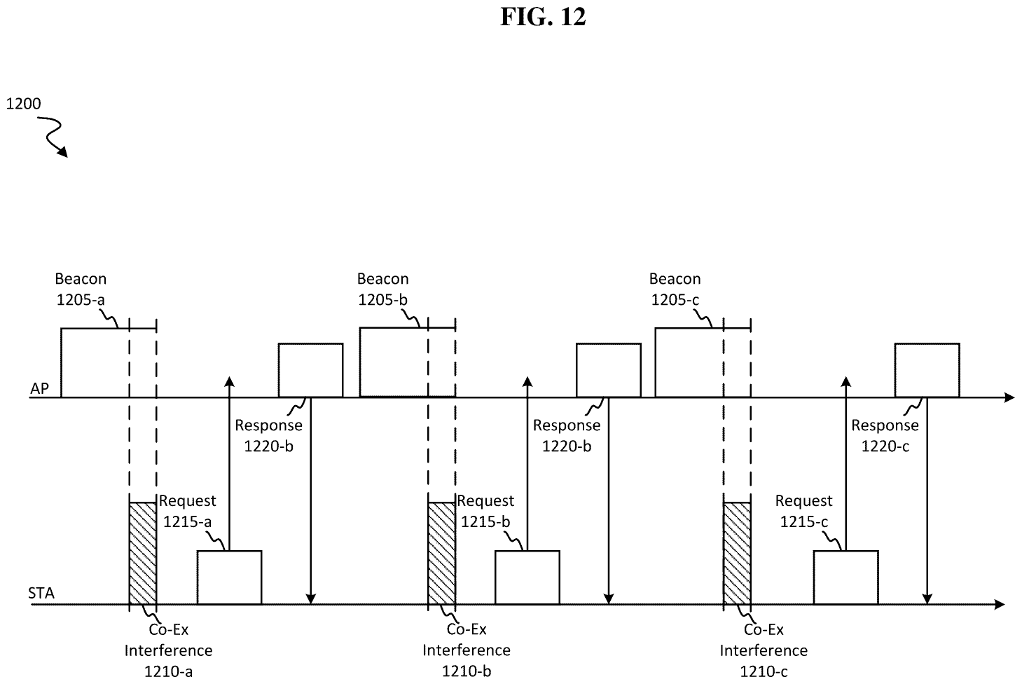

FIG. 12 illustrates an example co-existence message transmission 1200 in accordance with an embodiment. In at least one embodiment, the co-existence message transmission 1200 is between an AP and an STA.

As described with reference to FIG. 6, in some embodiments, the co-existence interference can be periodic. For example, as illustrated in FIG. 12, each time the AP transmits a beacon 1205, the STA experiences a co-existence interference 1210—e.g., when the AP transmits beacon 1205-a, the STA experiences a co-existence interference 1210-a. In at least one embodiment, the STA can determine the co-existence interference based on the process described with reference to FIG. 11—e.g., based on decoding sub-blocks of beacon 1205. In other examples, the co-existence interference 1210 can be scheduled, random, aperiodic, etc.

In at least one embodiment, the STA can indicate the co-existence interference 1210 (e.g., a co-existence constraint) to the AP. For example, the STA can transmit a message to the AP that indicates there is a co-existence interference 1210-a upon receiving the beacon 1205-a from the AP. In at least one embodiment, the STA can indicate the co-existence interference 1210 in a request message 1215. In at least one embodiment, the STA message informing the AP about the co-existence interference (e.g., constraint) can include at least one of the following information items shown in Table 6:

TABLE 6

| Information Item | Description |
|---|---|
| Nature of | One or more information items that can |
| interference | indicate a nature of interference—e.g., indicate |
| | that the co-existence interference 1210 is |
| | periodic, aperiodic, scheduled, random, etc. |
| Periodicity | One or more information items that can |
| | indicate the periodicity of the co-existence |
| | interference 1210 |
| Start Time | One or more information items that indicate a |
| | start time of the co-existence interference |
| | 1210. |

In at least one embodiment, the information items listed in Table 6 can be transmitted or separately as part of the co-existence notification message. In some embodiments, the information items listed in Table 6 can be included or transmitted as part of an existing IEEE 802.11 frame, element, field, or subfield. In other embodiments, the information items listed in Table 6 can be transmitted in a newly defined frame, element, field, or subfield.

In at least one embodiment, the AP can receive the message about the co-existence interference (e.g., constraint) and assess the coexistence issue and determine when the co-existence interference occurs—e.g., the AP can assess the coexistence issue when feasible or the AP is available to do so. In at least one embodiment, the STA can also notify the AP if the co-existence interference 1210 is no longer present or valid—e.g., the STA can transmit a second message including information regarding the lapse of the coexistence interference 1210.

In at least one embodiment, the STA can request the information from the beacon 1205 that was not received due to the co-existence interference 1210 via request 1215. That is, the STA can transmit a request 1215 for a portion of beacon 1205 from the AP. In at least one embodiment, the STA can transmit the request 1215 including at least one of the following information items indicated in Table 7:

TABLE 7

| Information | |
|---|---|
| Item | Description |
| Portion | One or more information items that can indicate the portion of the beacon that |
| Indicator | the STA is requesting from the AP. |
| | Example 1: A bitmap in which each bit can correspond to one field or element |
| | that can be present in the AP's beacon 1205. |
| | Example 2: An indication of a portion of the beacon 1205 during which the |
| | beacon 1205 was not correctly received—e.g., the portion affected by co- |
| | existence interference 1210. |
| Start Position | One or more information items that can indicate the start position from which |
| Indicator | the beacon 1205 face interference |
| | Example 1: The closest beacon sub-block as described with reference to FIG. |
| | 11 |
| | Example 2: Timing information relative to a timing synchronization function |
| | (TSF) timer at which the interference started |
| End Position | One or more information items that can indicate the end position from which |
| Indicator | the beacon 1205 did not face interference or was correctly decoded |
| | Example 1: The closest beacon sub-block as described with reference to FIG. |
| | 11 |
| | Example 2: Timing information relative to a timing synchronization function |
| | (TSF) timer at which the interference ended |
| Request for | One or more information items that can indicate the STA is requesting for |
| Retransmission | retransmission of the indicated portion—e.g., requesting retransmission of the |
| Indication | portion of the beacon 1205 not properly received. |

In at least one embodiment, the information items listed in Table 7 can be transmitted or separately as part of the co-existence notification message. In some embodiments, the information items listed in Table 7 can be included or transmitted as part of an existing IEEE 802.11 frame, element, field, or subfield. In other embodiments, the information items listed in Table 7 can be transmitted in a newly defined frame, element, field, or subfield.

In at least one embodiment, the AP can receive the request 1215 from the STA. In such embodiments, the AP can process the request, and upon processing the request 1215, the AP can transmit a response 1220 including the beacon 1205 portion requested. In at least one embodiment, the AP can transmit the response message 1220 at a higher data rate than the beacon 1205 because the response message 1220 is directed to the particular STA. In at least one embodiment, the STA can also acknowledge the response message—e.g., the STA can indicate it has received the missing beacon 1205 portions. Accordingly, by using the response and request messages following the co-existence interference, the STA can receive the full beacon 1205.

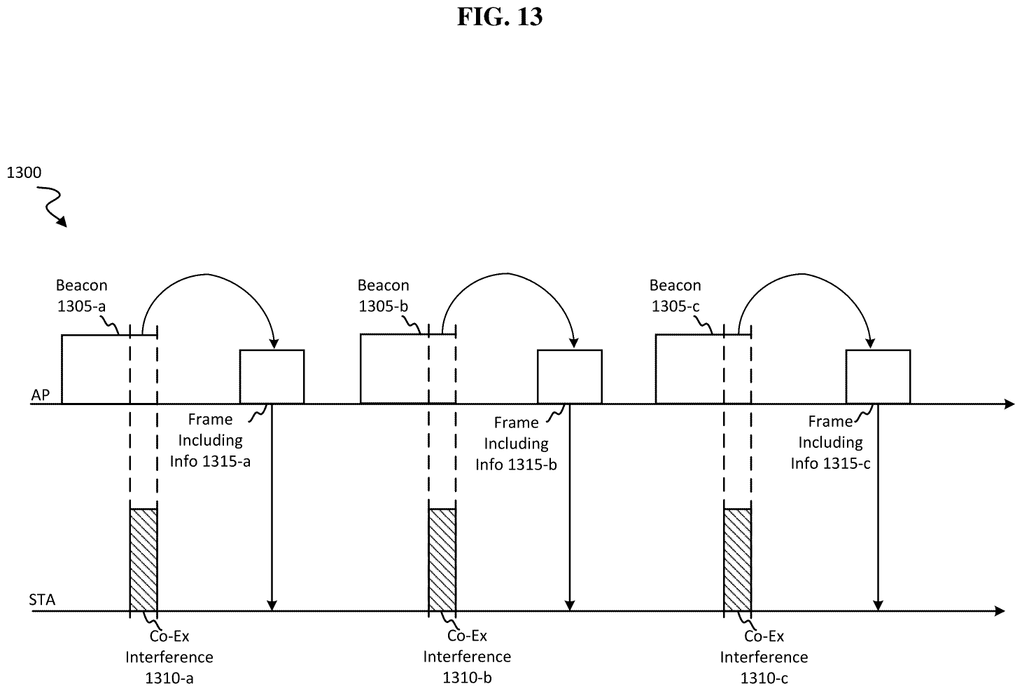

FIG. 13 illustrates an example co-existence message transmission 1300 in accordance with an embodiment. In at least one embodiment, the co-existence message transmission 1300 is between an AP and an STA.

As described with reference to FIG. 6, in some embodiments, the co-existence interference can be periodic. For example, as illustrated in FIG. 13, each time the AP transmits a beacon 1305, the STA experiences a co-existence interference 1310—e.g., when the AP transmits beacon 1305-a, the STA experiences a co-existence interference 1310-a. In at least one embodiment, the STA can determine the co-existence interference based on the process described with reference to FIG. 11—e.g., based on decoding sub-blocks of beacon 1305. In other examples, the co-existence interference 1310 can be scheduled, random, aperiodic, etc.

In at least one embodiment, because the STA is continuously experiencing co-existence interference (e.g., or experiencing known co-existence interference), the AP can offload information specific to the STA being interfered with from a beacon 1305 into a separate frame 1315 that includes the beacon portion not properly received by the STA. For example, the AP can transmit a beacon 1305 to a plurality of STAs. In at least one embodiment, the AP can recognize or otherwise determine the STA does not receive at least a portion of the beacon 1305 due to the co-existence interference 1310—e.g., based on the STA notifying the AP of the co-interference as described with reference to FIG. 12. Accordingly, the AP can transmit a separate second frame 1315 including the information that was not received by the STA due to the interference 1310. In at least one embodiment, the STA receives common information from the beacon 1305 that is relevant to the entire BSS via a probe request (e.g., the STA can receive the beacon 1305 information not interfered with by the co-existence interference 1310) and information that is relevant to the STA (e.g., the information the STA could not receive from beacon 1305 due to the co-existence interference 1310) is included in different frame 1315 that is specifically addressed to the STA. In at least one embodiment, the frame 1315 including the information is transmitted at a higher rate (e.g., at a higher modulation and coding scheme (MCS)) thus reducing airtime consumption—e.g., because the frame 1315 is directed specifically to the STA, it can be transmitted at the higher MCS.

In at least one embodiment, the STA can inform the AP about the periodicity of a coexistence constraint as described with reference to FIG. 12. In such embodiments, the AP can assess if the STA would have faced co-existence interference 1310 and transmit relevant information to the STA in the separate frame 1315.

In some embodiments, the STA can transmit a probe request at a higher data rate than a base rate—e.g., the STA can transmit the probe request using similar MCS as that used for data frame transmission. In at least one embodiment, the AP can also respond to the probe request with a probe response that is transmitted at higher data rate than the base rate. In such embodiments, the duration of airtime consumed by each frame transmission (e.g., probe request or probe response) is reduced.

In one embodiment, the STA can indicate to the AP which link suffers from the coexistence interference or constraint. In such embodiments, the AP can transmit STA specific information in beacons on the other links—e.g., the links not affected by the coexistence interference or constraint. In at least one embodiment, the STA and AP can perform a negotiation to determine the link on which the information can be transmitted.

In at least one embodiment, an AP that can provide co-existence interference support can advertise its capability to the STA in one or more frames the AP transmits to the STA. For example, the AP can indicate the capability in management frames such as beacon frames, probe response frames, etc. Accordingly, the STA can determine if the AP can provide the requisite support.

In at least one embodiment, an STA that can understand the AP's capability frames can advertise its own capability to the AP—e.g., the AP can indicate it supports co-existence interference and if the STA also supports mechanisms to reduce co-existence interference, the STA can acknowledge the capabilities to the STA. Accordingly, the AP can determine the STA can respond appropriately.

In at least one embodiment, the procedures described herein (e.g., a method to setup, modify, or terminate a co-existence session) can be used for non-infrastructure Wi-Fi—e.g., for P2P, relay, mobile AP, etc.

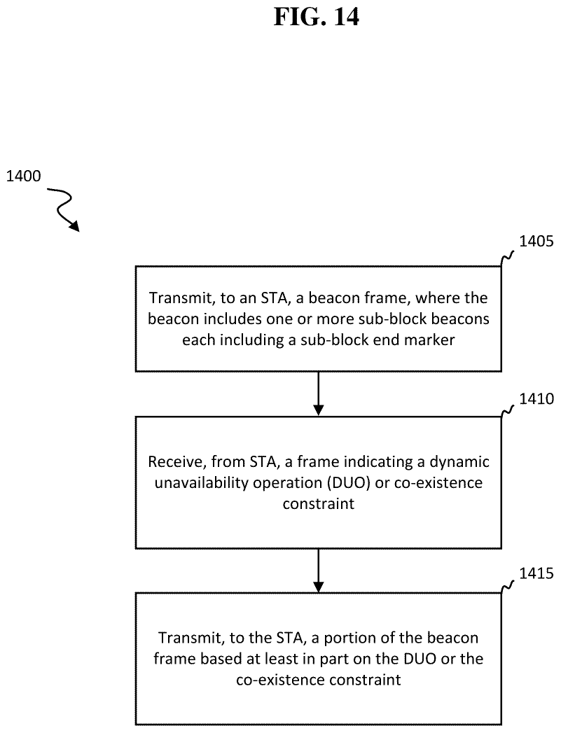

FIG. 14 shows an example process 1400 for beacon management in accordance with an embodiment. For explanatory and illustration purposes, the process 1400 may be performed by an access point (AP) and station (STA) as described with reference to FIGS. 12-13. Although one or more operations are described or shown in a particular sequential order, in other embodiments the operations may be rearranged in a different order, which may include performance of multiple operations in at least partially overlapping time periods.

Referring to FIG. 14, the process 1400 may begin in operation 1405. At operation 1405, an AP can transmit, to an STA, a beacon frame. In some embodiments, the beacon frame can have a format as described with reference to FIG. 11. That is, the beacon includes one or more beacon sub-blocks where each beacon sub-block includes a sub-block end marker. In at least one embodiment, the sub-block end marker can be a frame check sequence (FCS). Accordingly, the beacon transmitted by the AP can be decoded beacon sub-block by beacon sub-block. As described with reference to FIG. 12 and FIG. 13, the STA can experience co-existence interference—e.g., experience dynamic unavailability. In some embodiments, the co-existence interference is a result of a non-WiFi radio technology. In at least one embodiment, the co-existence interference is a second radio technology in the STA—e.g., the STA can include multiple radio technologies. In either embodiment, the STA can determine that at least a portion of the beacon was not received—e.g., a portion of the beacon was not decoded. In at least one embodiment, the STA can determine the beacon was not decoded properly based on a latest or next beacon sub-block end marker decoded as described with reference to FIGS. 11-13. For example, the STA can determine each beacon sub-block includes five (5) sub-block end markers. In at least one embodiment, the STA can decode a first four sub-block end markers but not decode the fifth sub-block end marker. In such embodiments, the STA can determine the STA did not properly receive the beacon because the fifth beacon sub-block end marker was not decoded.

At operation 1410, the AP can receive, from the STA, a frame indicating a dynamic unavailability operation (DUO) or a co-existence constraint—e.g., the STA can indicate a presence of a co-existence interference to the AP. In at least one embodiment, the frame can include a nature of interference, a periodicity, or a start time as described with reference to FIG. 12. In at least one embodiment, the frame can also include a request for a portion of the beacon frame—e.g., a request for the beacon portion that was not received properly by the STA. For example, the frame can include at least one of a portion indicator, a start position indicator, an end position indicator, or a request for retransmission. In some embodiments, the STA can notify the AP of the co-existence constraint before the AP transmits the beacon frame. In such embodiments, the AP can transmit, to the STA, a separate frame including the beacon information without the STA requesting the information as described with reference to FIG. 13.

At operation 1415, the AP can transmit, to the STA, a portion of the beacon frame based at least in part on the DUO or the co-existence constraint. For example, the AP can transmit the beacon information the STA did not receive. In at least one embodiment, the AP can transmit the portion of the beacon frame based on receiving the STA's frame at operation 1410 as described with reference to FIG. 12. In other embodiments, the AP can transmit the portion of the beacon information based on a known co-existence constraint at the STA. That is, the AP can transmit the portion of the beacon in a separate frame without a request from the STA as described with reference to FIG. 13. In at least one embodiment, the AP can transmit the portion of the beacon frame at a first data rate and transmit the beacon frame at a second data rate, where the first data rate is greater than the second data rate. That is, the AP can transmit the portion of the beacon frame at a higher data rate or with a higher modulation coding scheme (MCS).

In at least one embodiment, the frame from the STA can include a link indication—e.g., the frame can indicate which links between the STA and AP experience the co-existence constraint. In at least one embodiment, the STA can also transmit a probe request at the first data rate—e.g., the STA can transmit a request for the portion of the beacon frame at higher data rate.

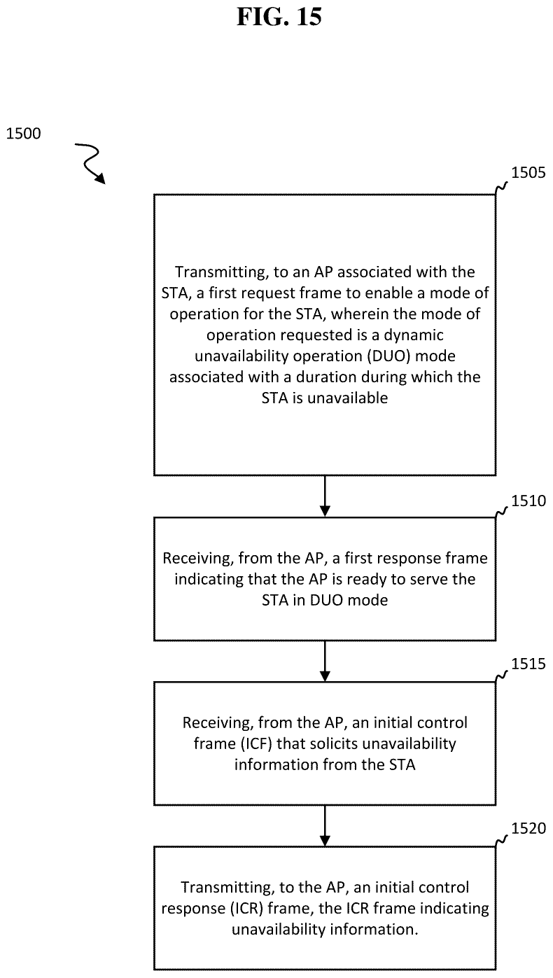

FIG. 15 shows an example process 1500 for a dynamic availability operation (DUO) mode (e.g., co-existence session) in accordance with an embodiment. For explanatory and illustration purposes, the process 1500 may be performed by a co-existence session initiator (e.g., a co-existence session initiator 705 representing an STA or AP) and a co-existence responder (e.g., co-existence responder 710 representing an AP or STA) as described with reference to FIG. 7. In some embodiments, the AP can be an example of a multi-link device AP—e.g., an AP MLD. In such embodiments, the STA can be an example of a non-AP MLD. In at least one embodiment, the AP can have one or more links coupling the AP MLD with the non-AP MLD. Although one or more operations are described or shown in a particular sequential order, in other embodiments the operations may be rearranged in a different order, which may include performance of multiple operations in at least partially overlapping time periods.

Referring to FIG. 15, the process 1500 may begin in operation 1505. At operation 1505, an STA can transmit, to an access point (AP) associated with the STA, a first request frame to enable a mode of operation for the STA, wherein the mode of operation requested is a dynamic unavailability operation (DUO) mode associated with a duration during which the STA is unavailable—e.g., during a duration indicated by the STA of unavailability. That is, as described with reference to FIG. 7, the STA can be unavailable due to interference (e.g., co-existence interference). For example, the STA device can also include Bluetooth capabilities and the STA can initiate the DUO mode to reduce Wi-Fi transmissions from being effected by the Bluetooth capabilities. In at least one embodiment, the first request frame includes a field set to a first value to indicate the request to enable the DUO mode. In one embodiment, the field is a DUO subfield set to a value of one ‘1’ to indicate the request to enable the DUO mode. In at least one embodiment, the first request frame includes at least one of one or more links for which the first request applies for or parameters corresponding to the mode of operation. In some embodiments, the first request frame can include the mode of operation that is requested to be enabled. In some embodiments, the ICR frame can include at least one of an unavailability target start time indicating a specific point in time the STA will be unavailable or an unavailability duration indicating how long the STA is unavailable. In some embodiments, the unavailability target start time or the unavailability duration are examples of the co-existence session duration or co-existence session start time as described with reference to FIGS. 7-10. In at least one embodiment, the first request frame includes at least one of an indication of a type of radio technology interference at the STA (e.g., Bluetooth peer to peer (P2P), ultrawide band (UWB), ZigBee, etc.), a type of traffic with which the DUO mode is associated, or a link indication identifying (e.g., a co-existence type, a traffic type, link indication as described with reference to FIGS. 7-10, respectively). In at least one embodiment, the corresponding parameters of the mode indicated in the first request frame can be any of the information items described with reference to Tables 1-4. In one embodiment, the first request frame can be exchanged via management frames (e.g., action frames). For example, the first request frame can be an example of a link reconfiguration request frame and a response from an AP can be considered a link reconfiguration notify frame. In such embodiments, an action field of the link reconfiguration notify frame can indicate a meaning of the link reconfiguration notify frame, where the action field is encoded according to Table 5 described above. In at least one embodiment, the first request frame can be can example of an operating mode parameter (OMP) request frame. In such examples, the STA can transmit the OMP request frame to enable or disable one or more modes of operation for one or more affiliated non-STAs operating on enabled links.

In at least one embodiment, the STA can receive, a third, where the third frame includes a field indicating an operating mode timeout value, and where the STA receives the first response frame from the AP within a timeout interval that starts at an end of a physical layer protocol data unit (PPDU) carrying the first request frame, and where the timeout value is initialized to the operating mode timeout value indicated in the field. In some embodiments, the AP can fail to respond within the timeout interval. In such embodiments, the STA can transmit the first request again after the timeout interval has elapsed or the STA can treat a lack of a response within the timeout interval as a rejection of the first request. In some embodiments, the AP can transmit the third frame before receiving the first request frame. In other embodiments, the AP can transmit the third frame after a start of DUO operation. In one embodiment, the AP can determine to change the operating mode timeout value. In such embodiments, the AP can transmit a fourth frame including a new operating mode timeout value. In some embodiments, the STA can store an operating mode time out value received from the AP. In such embodiments, the STA can utilize the stored operating mode timeout in a modification phase, for example.

At operation 1510, the STA receives, from the AP on the one or more links, a first response frame indicating that the AP is ready to serve the STA in the DUO mode. In at least one embodiment, the first response frame includes at least one of an indication of a response of whether the first request frame is accepted, delayed, or rejected, a type of traffic with which the DUO mode is associated, a DUO mode identification (ID) for the DUO mode, or a link indication identifying one or more links associated with the DUO mode (e.g., a response indication, a traffic type, a co-existence session indicator, or a link indication as described with reference to FIGS. 7-10, respectively). In at least one embodiment, the AP that receives the first request from its associated STA to enable, disable, or update the parameters of one or more modes should successfully transmit the first response frame (e.g., a OMP response frame) on an enabled link where the corresponding STA affiliated with the AP is in awake state and after all applicable APs are ready to serve their associated STAs in the requested mode of operation and the requested parameters and within the timeout interval discussed above. In one embodiment, the set up can be done implicitly. In such embodiments, the AP can refrain from transmitting a response message and can be ready to serve the STA based on the request frame transmitted.

At operation 1515, the STA can receive, from the AP, an initial control frame (ICF) that solicits unavailability information from the STA. In at least one embodiment, the AP can transmit the ICF as part of the DUO mode. In at least one embodiment, the ICF is a frame exchange that is neither group addressed data nor group addressed management frames with the STA.

At operation 1520, the STA can transmit, to the AP, an initial control response (ICR) frame, the ICR frame indicating unavailability information. In some embodiments, the unavailability information can refer to an unavailability or availability status of the STA. For example, the AP can transmit the ICF to request unavailability information and the STA can be available. Accordingly, the STA can transmit an ICR response indicating the STA is available (e.g., not unavailable).

In some embodiments, the STA can further transmit, to the AP, a second request frame to disable the mode of operation, the second request frame including the one or more links for which the second request applies and the mode of operation that is requested to be disabled, where the second request frame indicates a field value set to a first value to indicate the request to disable the DUO mode. That is, in some embodiments, the second request frame includes a DUO subfield having a value zero ‘0’ to indicate the request to disable the DUO mode. In some embodiments, the STA can receive, from the AP, a second request frame indicating the AP is no longer serving the STA in DUO mode in response to the first request frame. In at least one embodiment, the second request frame and second response frame can include one or more parameters discussed with reference to FIGS. 7-10, (e.g., a response indication, a traffic type, a co-existence session indicator, or a link indication). For example, the second request frame includes at least one of an indication that the second request frame is for the DUO mode or an indication of a session identification of the DUO mode.

In at least one embodiment, the STA is further to transmit, to the AP, a second request frame modify parameters associated with mode of operation, wherein the second request frame includes at least one of one or more links for which the second request applies for, the mode of operation for which the parameters are modified, and parameters to be modified. In some embodiments, the parameters to be modified includes at least one of a modification indication, an unavailability target start time indicating a specific point in time the STA will be unavailable, an unavailability duration indicating how long the STA is unavailable, a type of traffic with which the DUO mode is associated with, a DUO identification (ID) for the DUO mode, or a link indication identifying one or more links associated with the DUO mode. That is, the STA can update the parameters associated with one or more enabled modes for one or more of its links by transmitting the second request. In some embodiments, the second request can include enablement/disablement and update of parameters for the one or more links. In at least one embodiment, the STA is further to receive, from the AP, a second response frame indicating an acceptance by the AP of the second request to modify the parameters associated with the mode of operation.

By using a co-existence session procedure and beacon retransmission, the STA can reduce interference caused by a co-existence interference from a radio technology other than Wi-Fi.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. A station (STA) in a wireless network, comprising:
a memory; and
a processor coupled to the memory, the processor configured to cause:
transmitting, to an access point (AP) associated with the STA, a first request frame to enable a mode of operation for the STA, wherein the mode of operation requested is a dynamic unavailability operation (DUO) mode associated with a duration during which the STA is unavailable;
receiving, from the AP, a first response frame indicating that the AP is ready to serve the STA in the DUO mode;
receiving, from the AP, an initial control frame (ICF) that solicits unavailability information from the STA; and
transmitting, to the AP, an initial control response (ICR) frame, the ICR frame indicating unavailability information.

2. The STA of claim 1, wherein the processor is further configured to cause:
transmitting, to the AP, a second request frame to disable the mode of operation, wherein the second request frame includes a field value set to a first value to indicate the request to disable the DUO mode; and
receiving, from the AP, a second response frame indicating the AP is no longer serving the STA in the DUO mode in response to the second request frame.

3. The STA of claim 2, wherein the second request frame includes at least one of an indication that the second request frame is for the DUO mode, an indication of a session identification of the DUO mode, one or more links for which the second request applies for, or the mode of operation that is requested to be disabled.

4. The STA of claim 1, wherein the first request frame includes at least one of a field set to a first value to indicate the request to enable the DUO mode, one or more links for which the first request applies, the mode of operation that is requested to be enabled, and parameters corresponding to the mode of operation, an indication of a type of radio technology interference at the STA, or a type of traffic with which the DUO mode is associated.

5. The STA of claim 1, wherein the first response frame includes at least one of an indication of a response of whether the first request frame is accepted, delayed, or rejected, a type of traffic with which the DUO mode is associated, a DUO mode identification (ID) for the DUO mode, or a link indication identifying the one or more links associated with the DUO mode.

6. The STA of claim 1, wherein the processor is further configured to cause:
transmitting, to the AP, a second request frame to modify parameters associated with mode of operation.

7. The STA of claim 6, wherein the second request frame includes at least one of one or more links for which the second request applies for, the mode of operation for which parameters are modified, or parameters to be modified, and wherein the parameters include at least one of a modification indication, an unavailability target start time indicating a specific point in time the STA will be unavailable, an unavailability duration indicating how long the STA is unavailable, a type of traffic with which the DUO mode is associated with, a DUO identification (ID) for the DUO mode, or a link indication identifying one or more links associated with the DUO mode.

8. The STA of claim 6, wherein the processor is further configured to cause:
receiving, from the AP, a second response frame indicating an acceptance by the AP of the second request to modify the parameters associated with the mode of operation.

9. The STA of claim 8, wherein the parameters to be modified include at least one of a modification indication, an unavailability target start time indicating a specific point in time the STA will be unavailable, an unavailability duration indicating how long the STA is unavailable, a type of traffic with which the DUO mode is associated with, a DUO identification (ID) for the DUO mode, or a link indication identifying one or more new links associated with the DUO mode.

10. The STA of claim 1, wherein the processor is further configured to cause:
receiving, from the AP, a third frame, wherein the third fame includes a field indicating an operating mode timeout value, wherein the STA receives the first response frame from the AP within a timeout interval that starts at an end of a physical layer protocol data unit (PPDU) carrying the first request frame, and wherein the timeout interval is initialized to the operating mode timeout value indicated in the field.

11. An access point (AP) in a wireless network, comprising:
a memory; and
a processor coupled to the memory, the processor configured to cause:
receiving, from a station (STA) associated with the AP, a first request frame to enable a mode of operation for the STA, wherein the mode of operation requested is a dynamic unavailability operation (DUO) mode associated with a duration during which the STA is unavailable;
transmitting, to the STA, a first response frame indicating that the AP is ready to serve the STA in the DUO mode;
transmitting, to the STA, an initial control frame (ICF) that solicits unavailability information from the STA; and
receiving, from the STA, an initial control response (ICR) frame in response to the ICF, the ICR frame indicating unavailability information.

12. The AP of claim 11, wherein the processor is further configured to cause:
receiving, from the STA, a second request frame to disable mode of operation, wherein the second request frame includes a field value set to a first value to indicate the request to disable the DUO mode; and
transmitting, to the STA, a second response frame indicating the AP is no longer serving the STA in the DUO mode in response to the second request frame.

13. The AP of claim 12, the second request frame includes at least one of an indication that the second request frame is for the DUO mode, an indication of a session identification of the DUO mode, one or more links for which the second request applies for, or the mode of operation that is requested to be disabled.

14. The AP of claim 11, wherein the first request frame includes at least one of a field set to a first value to indicate the request to enable the DUO mode, an indication of a type of radio technology interference at the STA, a type of traffic with which the DUO mode is associated, one or more links for which the first request applies, the mode of operation that is requested to be enabled, and corresponding parameters of the mode of operation.

15. The AP of claim 11, wherein the first response frame includes at least one of an indication of a response of whether the first request frame is accepted, delayed, or rejected, a type of traffic with which the DUO mode is associated, a DUO mode identification (ID) for the DUO mode, or a link indication identifying the one or more links associated with the DUO mode.

16. The AP of claim 11 wherein the processor is further configured to cause:
receiving, from the STA, a second request frame to modify parameters associated with the mode of operation; and
transmitting, to the STA, a second response frame indicating an acceptance by the AP of the second request to modify the parameters associated with the mode of operation.

17. The AP of claim 11, wherein the second request frame includes at least one of one or more links for which the second request applies, the mode of operation for which parameters are modified, or parameters to be modified, wherein the parameters include at least one of a modification indication, an unavailability target start time indicating a specific point in time the STA will be unavailable, an unavailability duration indicating how long the STA is unavailable, a type of traffic with which the DUO mode is associated with, a DUO identification (ID) for the DUO mode, or a link indication identifying one or more links associated with the DUO mode.

18. The AP of claim 11, wherein the processor is further configured to cause:
transmitting, to the STA, a third frame, wherein the third frame includes a field indicating an operating mode timeout value, and wherein the AP transmits the first response frame within a timeout interval that starts at an end of a physical layer protocol data unit (PPDU) carrying the first request frame, wherein the timeout interval is initialized to the operating mode timeout value indicated in the field.

19. A method performed by a station (STA) in a wireless network, comprising:
transmitting, to an access point (AP) associated with the STA, a first request frame to enable a mode of operation for the STA, wherein the mode of operation requested is a dynamic unavailability operation (DUO) mode associated with a duration during which the STA is unavailable;
receiving, from the AP, a first response frame indicating that the AP is ready to serve the STA in the DUO mode;
receiving, from the AP, an initial control frame (ICF) that solicits unavailability information from the STA; and
transmitting, to the AP, an initial control response (ICR) frame in response to the ICF, the ICR frame indicating unavailability information.

20. The method of claim 19, further comprising:
transmitting, to the AP, a second request frame to disable the mode of operation, wherein the second request frame includes a field value set to a first value to indicate the request to disable the DUO mode; and
receiving, from the AP, a second response frame indicating the AP is no longer serving the STA in the DUO mode in response to the second request frame.
